(19) United States
(12) Patent Application Publication
(10) Pub. No.: US 2026/0163929 A1
(43) Pub. Date: Jun. 11, 2026

(54) Methods and Systems to Provide Optimized and Prioritized Telecommunications Services to Authorized Personnel

(71) Applicant: T-Mobile Innovations LLC, Overland Park, KS (US)

(72) Inventors: Mark Bonn, Granite Bay, CA (US); Dominick Mangiardi, Fremont, CA (US); Tariq Mohiuddin, Santa Clara, CA (US); John Susbilla, Milpitas, CA (US)

(21) Appl. No.: 18/977,805

(22) Filed: Dec. 11, 2024

(51) Int. Cl. H04L 65/1104; H04W 4/90; H04W 12/06

(52) U.S. Cl. CPC H04L 65/1104; H04W 4/90; H04W 12/068

(57) ABSTRACT

A method comprises receiving, by an application executing at an emergency telecommunications service system, from a user device, a Session Initiation Protocol (SIP) invite comprising a first header carrying a device identifier of the user device and an X-header carrying a personal identification number (PIN) of an authorized user operating the user device and a destination number requested by the user device, authenticating, by the application, the PIN as being associated with a valid user account at the emergency telecommunications service system, and completing, by the application, a call from the user device to the destination number.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Emergency telecommunications services, such as the Government Emergency Telecommunications Service (GETS) and Wireless Priority Service (WPS), are priority telecommunication services provided by the government to ensure that essential emergency personnel and/or other registered personnel have expedited access to communication networks during emergency situations. For example, a GETS system providing GETS operates using existing telecommunication infrastructure and grants authorized users priority status by authenticating the emergency personnel who have valid accounts registered with the GETS system. A WPS system provides authorized users with prioritized access to cellular networks during emergencies, ensuring that critical calls can be completed over wireless networks even during network congestion. This prioritized access ensures that critical communications from the emergency personnel are given precedence over non-priority communications and are not hindered by network congestion during emergency situations. In this way, the authorized emergency personnel can swiftly make and receive calls during emergency situations, enabling efficient and vital communication in times of heightened demand.

### SUMMARY

In an embodiment, a method implemented in a communication network to provide optimized and prioritized telecommunication services to authorized users is disclosed. The method comprises provisioning, by a dialer application executed at a user device in the communication network, an access number associated with an access network and a personal identification number (PIN) uniquely assigned to an authorized user operating the user device. After the PIN and the access number are provisioned with the dialer application, the method further comprises receiving, by the dialer application, a destination number via a user interface at the user device, generating, by the dialer application, a Session Initiation Protocol (SIP) invite including a device identifier identifying the user device and one or more X-headers, wherein the one or more X-headers comprises the PIN and the destination number, and transmitting, by the dialer application, the SIP invite to an emergency telecommunications service system. The method further comprises extracting, by an application executed at the emergency telecommunications service system, the PIN from the one or more X-headers of the SIP invite, authenticating, by the application, the PIN as being associated with a valid user account at the emergency telecommunications service system, extracting, by the application, the destination number from the one or more X-headers of the SIP invite, determining, by the application, that the user device is permitted to connect to the destination number based on a permission associated with the valid user account, and completing, by the application, a call from the user device to the destination number.

In another embodiment, a user device is disclosed. The user device comprises a processor and a dialer application stored in a non-transitory memory of the user device. The dialer application, when executed by the processor, is configured to provision a personal identification number (PIN) uniquely assigned to an authorized user operating the user device, receive a destination number via a user interface after the PIN is provisioned, encrypt the PIN based on a predefined encryption algorithm and a key to obtain an encrypted PIN, and generate a Session Initiation Protocol (SIP) invite including a first header, a second header, and an X-header. The second header comprises a cell site location of a cell site serving the user device, and the X-header comprises the encrypted PIN and the destination number. The dialer application is further configured to transmit the SIP invite to an emergency telecommunications service system.

In yet another embodiment, a method is disclosed. The method comprises receiving, by an application executing at an emergency telecommunications service system, from a user device, a Session Initiation Protocol (SIP) invite comprising a first header carrying a device identifier of the user device and an X-header carrying a personal identification number (PIN) of an authorized user operating the user device and a destination number requested by the user device. The method further comprises extracting, by the application, the PIN and the destination number from the X-header, authenticating, by the application, the PIN as being associated with a valid user account at the emergency telecommunications service system, and completing, by the application, a call from the user device to the destination number.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication system according to various embodiments of the disclosure.

FIGS. 2A and 2B are diagrams illustrating messages including X-headers that are forwarded through the communication system of FIG. 1 according to various embodiments of the disclosure.

FIG. 3 is a message sequence diagram illustrating a method of providing optimized and prioritized telecommunication services using the messages of FIGS. 2A and 2B according to various embodiments of the disclosure.

FIG. 4 is a flowchart of a first method of providing optimized and prioritized telecommunication services to authorized personnel in the communication system of FIG. 1 using the messages of FIGS. 2A and 2B according to various embodiments of the disclosure.

FIG. 5 is a flowchart of a second method of providing optimized and prioritized telecommunication services to authorized personnel in the communication system of FIG. 1 using the messages of FIGS. 2A and 2B according to various embodiments of the disclosure.

FIG. 6 is a message sequence diagram illustrating a first method of pre-authenticating user devices operated by authorized personnel to use the optimized and prioritized telecommunication services in the communication system of FIG. 1 according to various embodiments of the disclosure.

FIG. 7 is a message sequence diagram illustrating a second method of pre-authenticating user devices operated by authorized personnel to use the optimized and prioritized telecommunication services in the communication system of FIG. 1 according to various embodiments of the disclosure

FIG. 8 is a message sequence diagram illustrating a third method of pre-authenticating user devices operated by authorized personnel to use the optimized and prioritized telecommunication services in the communication system of FIG. 1 according to various embodiments of the disclosure.

FIG. 9 is a flowchart of a first method of providing optimized and prioritized telecommunication services to authorized personnel in the communication system of FIG. 1 by pre-authenticating user devices according to various embodiments of the disclosure.

FIG. 10 is a flowchart of a second method of providing optimized and prioritized telecommunication services to authorized personnel in the communication system of FIG. 1 by pre-authenticating user devices according to various embodiments of the disclosure.

FIG. 11 is a block diagram of a computer system implemented within the communication system of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, emergency telecommunications service systems (e.g., Government Emergency Telecommunications Service (GETS)) is a priority telecommunication service that ensures emergency/first responders, authorized national security, emergency personnel, and/or other types of authorized personnel (sometimes referred to herein as “users”) have prioritized access to communication networks during emergency situations. For a user to register with GETS, a user may first submit an application to a GETS system, in which the user may submit eligibility credentials and/or other types of evidence verifying that the user is indeed an emergency/first responder, public safety official, national security personnel, government official, infrastructure, healthcare professional, or other emergency personnel. The GETS system (or the GETS program administrator/designated authority) may verify the submitted eligibility credentials, and when verified, issue verification credentials to the emergency personnel. The verification credentials may be issued in the form of a physical or digital card. The verification credentials may be, for example, a personal identification number (PIN) (e.g., 12-digit numerical PIN, or any other number of digits), an alphanumeric PIN, a unique identifier, or any other form of a verification credential. For example, the PIN (or other verification credential) may serve as an authentication key for accessing priority telecommunication services during emergencies. A similar registration process may be performed for WPS services with a WPS system.

During an emergency, the user may operate a user device (e.g., mobile phone, landline phone, etc.) to initiate a call with a designated line (e.g., an access number or phone number associated with a telecommunications service provider) to the GETS system for authentication. After initiating the call, the user may listen (e.g., via a speaker of the device) for an indication (e.g., dial tone, beep, etc.) signaling to the user to enter the PIN. The user may then manually enter each digit of the PIN via the keypad of the user device. Alternatively, the user may speak each digit of the PIN into the microphone of the user device (e.g., say “9” – “7” – “2” – etc. into the microphone).

When the user enters the PIN into the keypad of the user device, the PIN may be forwarded through an access network associated with the telecommunications service provider to an application executing on a computer within the GETS system. The PIN may be sent over a Real-time Transport Protocol (RTP) stream (e.g., the entered PIN may be forwarded as Dual-Tone Multi-Frequency (DTMF) tones over the RTP stream). When the user speaks the PIN into the microphone of the user device, audio signals of the user speaking the PIN may be forwarded through the access network to the application via the RTP stream, and the application may perform voice-to-text conversion (e.g., speech recognition) on the recording to obtain the PIN provided by the user. The application then verifies the received PIN against stored credentials (e.g., the stored PIN) associated with active user accounts stored at the GETS system. When the PIN is valid (matches the stored credentials), the user is granted access to GETS. The application may then prompt the user to provide a destination number to communicate with using GETS, and the user may input the destination number into the user device (e.g., again via manual entry of the destination phone number using the keypad or speaking the destination phone number into the microphone, forwarded through the network in the RTP stream). The application may then connect the user device to the destination if the connection is permitted. As mentioned above, the connected call may be processed by the GETS system with priority, ensuring an expedited and secure connection that may be exempt from overload control (i.e., prevented from being disconnected during, for example, times of high network congestion).

As used herein, the term “PIN” may refer to a series of alphanumeric digits that have been uniquely assigned to an authenticated/registered user of the emergency system, and the PIN may be associated with a valid user account at the emergency system. The user account may include data describing an access history of the user (e.g., the device identifiers of devices authenticated using the PIN that accessed the emergency system, locations of the devices, times of authentication, prior destination numbers, etc.). In some cases, the term “PIN” may also refer to other types of verification criteria that the emergency system may use to authenticate users with valid user accounts. For example, the PIN may refer to verification criteria such as a voice recording of the user speaking the PIN, a voiceprint (e.g., a voice recording of the user speaking a passphrase/abbreviated PIN or phrase), a facial scan image, a fingerprint, or any other form of data (e.g., string of characters, image, recording, signal, etc.) that may be compared with a corresponding verification credential stored in a user account at the emergency system for authentication. The comparison may be performed using an AI model to match patterns in the verification credentials using various AI or neural network algorithms. The use of a voiceprint to authenticate a user with the GETS system is further described in U.S. Pat. App. No. 18/677,876, entitled “Methods and Systems to Provide Emergency Telecommunications Services to Emergency Personnel using Voice Verification,” by Mark Bonn, et. al., which is hereby incorporated by reference in its entirety.

Therefore, the initial login and authentication process with the GETS system is cumbersome, complex, and prone to user error, causing low call completion rates and increased call complexity. For the user to receive access to the privileges of GETS (or any other type of emergency/prioritized telecommunications service), the user may have to remember a 12-digit PIN/have access to a physical paper or card indicating the 12-digit PIN during an emergency situation and may have to manually enter or speak each digit of the PIN into the user device. Otherwise, the user may have to memorize a voice passphrase and speak the voice passphrase into the microphone of the user device. Moreover, the manual entry or speaking of the PIN/voice passphrase is often performed during a high-stress emergency situation. For example, the user may have to repeatedly enter the PIN into the keypad of the user device during a high-stress emergency situation until the user is concentrated enough to correctly enter the PIN. If the user is a type of emergency personnel that has to make dozens of rapid calls during an emergency situation (e.g., an emergency medical technician), this cumbersome process of manually entering the PIN becomes especially problematic – possibly resulting in delayed calls, dropped calls, inability to access GETS, etc.

Therefore, the initial steps for GETS authentication is technically problematic for numerous reasons. First, the manual entry or speaking of the PIN/voice passphrase significantly increases call setup time and call complexity for emergency response calls, since providing this information is a time-intensive process. For example, the user may have to re-enter the PIN multiple times until the user can accurately enter the PIN (since the user may not be able to concentrate to manually enter the PIN accurately under stress in the emergency situation). In addition, the card including the PIN may be susceptible to loss and theft, and the PIN may be vulnerable to hacking, fraud, and other misuse. Lastly, manual entry of a 12-digit PIN may be susceptible to human error, which may result in the user losing prioritized access to the network during emergencies. Therefore, GETS authentication may be inefficient from a network resource and processing resource perspective due to the increased call setup time and call complexities involved in PIN authentication. Moreover, GETS authentication may be prone to error, which may again result in the loss of prioritized communications for those directly involved in emergency management and national security efforts.

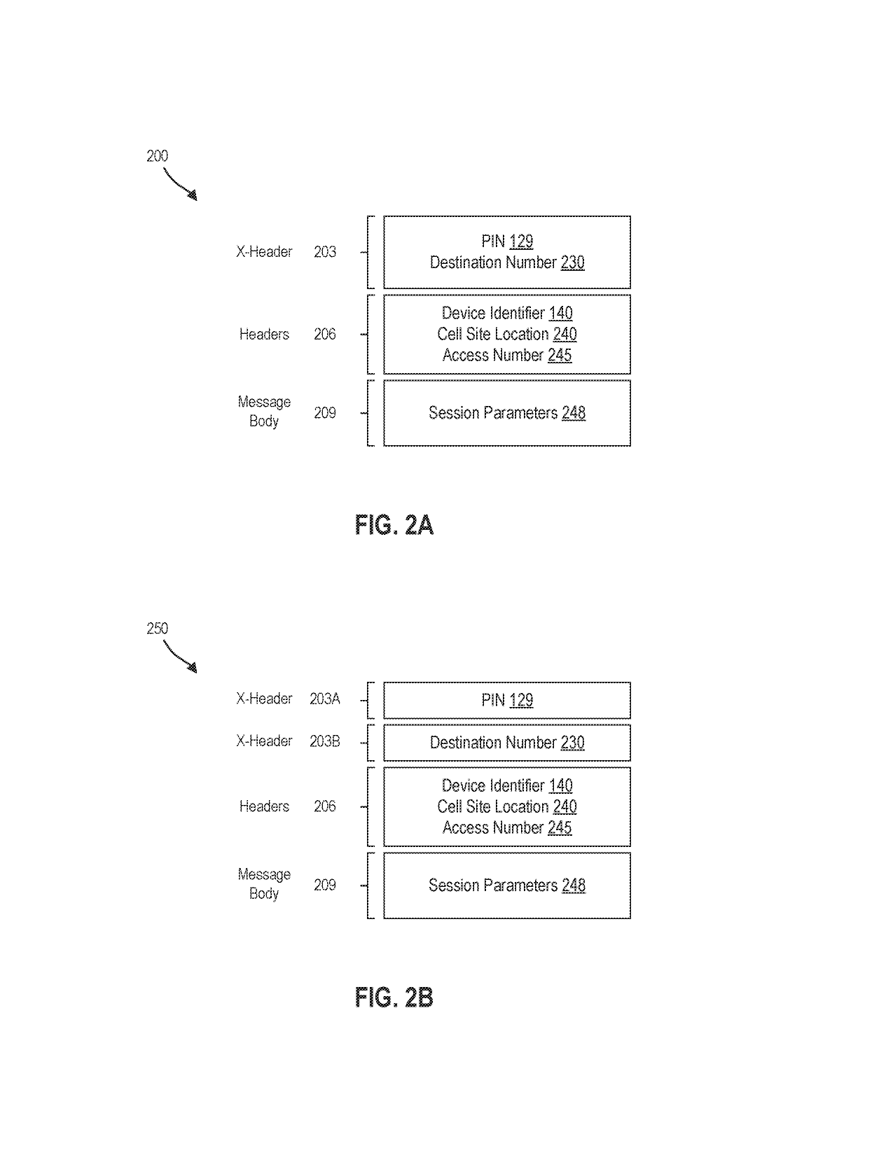

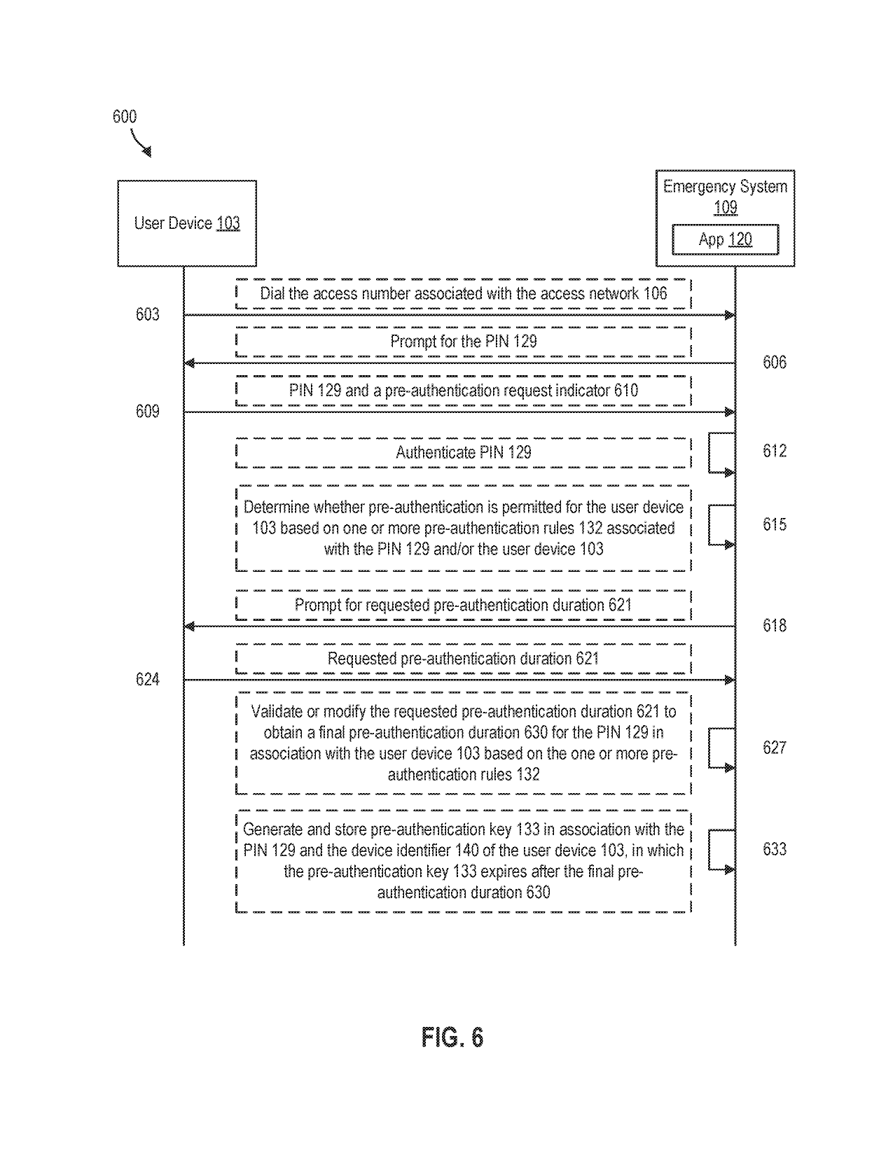

The present disclosure addresses the foregoing technical problems by providing two technical solutions in the technical field of authentication systems, and in particular, those used by emergency or prioritized telecommunications service systems (e.g., the GETs system or other emergency telecommunications service system). The first solution involves the use of an X-header in transmitting the PIN and other information to the GETS system (referred to herein as the “Dialer Application X-Header Embodiment”). The Dialer Application X-Header embodiment is further described below and shown with reference to FIGS. 2-5 of the present disclosure. The second solution involves the pre-authentication of certain devices with the GETS system based on pre-authentication rules (referred to herein as the “Pre-Authentication Embodiment”). The Pre-Authentication embodiment is further described below and shown with reference to FIGS. 6-10 of the present disclosure.

The Dialer Application X-Header embodiment may utilize a dialer application provisioned at a user device, which is operated by a user that is registered with an emergency telecommunications service system (also referred to herein as “emergency system”). The dialer application may be a software application package programmed to simplify the process for authorized users to access the emergency system, by providing a user-friendly interface to automate accessing and authenticating with the emergency system. Instead of transporting the digits of the PIN and destination number as DTMF tones on the RTP stream, in the embodiments disclosed herein, the dialer application may generate a Session Initiation Protocol (SIP) invite with one or more X-headers carrying the PIN and/or the destination number. By transporting the PIN and/or destination number for an emergency call over the data stream as a single message, instead of over the RTP audio stream as separate tones, the embodiments disclosed herein greatly reduce call complexity and call setup time, while increasing probability of call completion – each of which has a significant impact during emergency situations.

This embodiment may be implemented in a communication network including the emergency system (e.g., the GETS system), which may include an application for authenticating user devices and implementing prioritized connections for the authenticated user devices. The system may also include an access network owned and operated by a telecommunications service provider. The access network may be the network subscribed to by the user for receiving prioritized access to the network resources. To this end, the access network may be associated with an access number (e.g., 10-digit telephone number), which may be dialed by the user device to request access to the emergency system.

First, the user operating the user device may install the dialer application (e.g., via an application store at the user device). As mentioned above, the user devices may be provisioned with a dialer application programmed to simplify the authentication and connection to the emergency system. After installation, the user device may provision, at the dialer application, the access number of the access network that the user is subscribed to or desires to use for emergency calls (e.g., the user may open the settings of the dialer application, and select a link or icon corresponding to a telecommunications service provider, in which the selection of the link/icon is a selection of an access number associated with the access network of the telecommunications service provider, which then is stored with the dialer application). The user may also provision the PIN at the dialer application (e.g., the user may open the settings of the dialer application, and manually type in the PIN via a user interface/physical keyboard of the user device, or speak the PIN into a microphone of the user device, which then is stored with the dialer application). In this way, the dialer application may pre-provision the access number used to access the emergency system and the PIN used to authenticate the user with the emergency system, prior to the user actually making emergency calls using the dialer application.

During an emergency situation, after the access number and PIN have been provisioned at the dialer application, the user may operate the user device and open the dialer application to enter a requested destination number (e.g., by manually typing the digits of the destination number into a touch keypad/physical keyboard or speaking the digits of the destination number into a microphone). The destination number may be any number of digits (e.g., 10-digits when the destination is a local US based destination) that may be used to connect with a destination device anywhere in the world. In another case, the dialer application may have access to a contact list of contacts (e.g., potential destination numbers) stored at the user device, and the user may select a contact as the destination number via the user interface of the dialer application.

The dialer application may then generate a SIP invite (or other encoded/formatted message), which includes key information for establishing a prioritized GETS call. For example, the SIP invite may include a device identifier (e.g., automatic number identification (ANI), a mobile station international subscriber directory number (MSISDN), phone number, etc.) of the user device (e.g., in the “From” header of the SIP invite). The SIP invite may include an identifier or location of the cell site serving the user device (e.g., in the “P-Access-Network-Info” header in the SIP invite).

In an embodiment, the dialer application may add one or more X-headers to the SIP invite, in which the one or more X-headers carry the pre-provisioned PIN and/or the destination number. An X-header is an additional header that may be optionally added to SIP messages, and network elements/applications that receive SIP messages with X-headers may ignore the information carried in the X-headers unless the information is applicable to the network element/application. The dialer application may obtain the pre-provisioned PIN from storage, add one X-header to the SIP invite, and add the PIN to the X-header (e.g., the user need not provide the PIN again upon providing the destination number). The dialer application may also add the destination number to the X-header with the PIN, or may add another, separate X-header with the destination number to the SIP invite. In some cases, the PIN may be encrypted before being added to the X-header. For example, the PIN may be encrypted according a predefined encryption algorithm using one or more public/private keys (e.g., a hash of the device identifier identifying the user device), prior to being added to the X-header.

The dialer application may then transmit the SIP invite with the one or more X-headers to the emergency system via the access network, based on the pre-provisioned access number associated with the access network. For example, the SIP invite may carry the pre-provisioned access number as the destination (e.g., in the “To” header of the SIP invite). The emergency system may consider the SIP invite a request, from the user device identified by the device identifier carried in the SIP invite, to receive a prioritized connection to a destination number carried in the X-header. To this end, an application at the emergency system may receive the SIP invite and extract the PIN from the X-header. The application may first decrypt the PIN using a predefined decryption algorithm and key(s) based on the corresponding encryption performed at the dialer application. The application at the emergency system may then authenticate the PIN by, for example, validating that the PIN is associated with a valid user account at the emergency system. The PIN may be considered authenticated when the PIN is stored with an active, valid user account (e.g., one that is currently associated with an authorized user that has actively registered and maintained registration with the GETS system). When the PIN is not stored with an active, valid user account, the PIN may not be authenticated with the emergency system, and the request in the SIP invite may be rejected.

Once authenticated, the application may then extract the destination number from the X-header, and verify that connecting the user device to the requested destination number is consistent with the permissions stored with the user account associated with the PIN. For example, when the destination number included in the X-header is an international destination number, and the permissions stored with the user account indicate that the user associated with the PIN may not use the emergency system for international calls, the system may reject the SIP invite to reject the request to use the emergency system to connect the user device to the destination number. In contrast, when the permissions stored with the user account indicate that the user associated with the PIN is permitted to use the emergency system for international calls, the system may initiate the connection procedure to connect the user device to the destination number.

In some embodiments, the destination may not need to be sent in an X-header, and instead only the PIN may be sent in the X-header. In this case, the application at the emergency system may first receive the SIP invite with the PIN in the X-header over the signaling data stream, authenticate the PIN with a valid user account, and then transmit a prompt back to the user device over the RTP audio stream (e.g., in the form of a DTMF tone). The user may provide the destination number to the dialer application, and the dialer application may transmit the destination number to the emergency system, also over the RTP audio stream. The application at the emergency system may perform the same permissions check mentioned above to determine whether to connect the user device to the requested destination number.

In these embodiments, at least the PIN (encrypted or not encrypted) is carried directly in the X-header of the initial SIP invite sent by the user device to the emergency system, greatly reducing the amount of time that may have otherwise been required to transmit the PIN as DTMF tones over the RTP audio stream. By transmitting the PIN and/or destination number in the X-header of the initial SIP invite, the emergency system may maintain records of the types of connections initiated with the emergency system, the success rate of the prioritized calls, and other metrics associated with prioritized network access using the emergency system. For example, the application at the emergency system may maintain records of all of the connections initiated via the dialer application using the X-header carrying the PIN (and records of the connections that were not initiated using the dialer applications at devices). These records may be stored in association with the PINs received from the user device, and the success or failure of the requested connections. The application may use these metrics, in some cases in conjunction with a trained artificial intelligence (AI) model, to perform error detections, predict anomalies in the types and nature of the received requests, detection of bot dialers, detection of denial of service attempts, etc. These metrics may also be used to generate corresponding reports detailing the logged records and the predicted identifiers errors/anomalies, which may be automatically reported to various government entities, sometimes to comply with various government regulations. In this way, the dialer application X-header embodiment significantly improves the efficiency and accuracy of completing a call with an emergency system during an emergency situation, while providing additional data for improving the system over time and complying with government regulations.

The pre-authentication embodiment may involve pre-authenticating certain user devices either automatically or in response to a pre-authentication request based on one or more pre-authentication rules. When a user device is pre-authenticated, a self-expiring pre-authentication key may be stored in the user account in association with the user device for a pre-authentication duration, such that the user device may receive prioritized network services using the emergency system during the pre-authentication duration (e.g., without repeatedly entering the PIN during the pre-authentication duration). By pre-authenticating a user device using a PIN, a user may not need to repeatedly provide the PIN to make consecutive calls during an emergency situation, thereby greatly reducing call complexity and call setup time, while increasing probability of call completion – each of which has a significant impact during emergency situations.

This embodiment may be implemented by the communication network described herein, including the emergency system, the user devices, and the access networks. The user may operate a user device and place a call (e.g., via a native dialer of the user device) to the access number associated with the access network, that may connect the user device to the emergency system. When the emergency system receives the call, the emergency system may return a prompt (e.g., a DTMF tone) that is heard at the user device, signaling the user to enter the PIN into the user device. The user may then manually enter the PIN via a user interface/keypad at the user device or by speaking into the microphone of the user device.

In an embodiment, the user may also enter a pre-authentication request indicator with the PIN. The pre-authentication request indicator may include another string of digits or characters, or another voice passphrase, which may be transmitted to the emergency system and interpreted as being a request for pre-authentication. For example, after manually typing the PIN at the user device, the user may also type “# #” – in which the string # # constitutes the pre-authentication request indicator. As another example, the user may speak the phrase “pre-authenticate” into the microphone as the pre-authentication request indicator. In some cases, the pre-authentication request indicator may be transmitted with the PIN to the emergency system (e.g., via the RTP stream).

The application at the emergency system may extract the PIN and the pre-authentication request indicator separately. The application may first identify the digits/passphrase of the PIN (in some cases, using the AI model) and authenticate the PIN by, for example, verifying that the PIN is stored with a valid user account at the emergency system. If so, the application may then extract the pre-authentication request indicator to determine that the user is requesting to pre-authenticate the user device with the emergency system. The application may then obtain one or more pre-authentication rules of the user account, which may indicate conditions, policies, and/or logic associated with pre-authenticating user devices based on the received PIN. For example, one pre-authentication rule may indicate whether user devices authenticating with the PIN are permitted to pre-authenticate, another pre-authentication rule may indicate a maximum pre-authentication duration for user devices authenticating with the PIN, yet another pre-authentication rule may indicate that different types of user devices authenticating with the PIN have different maximum pre-authentication durations, etc.

In this case, the application may first determine whether the user device is permitted to pre-authenticate with the emergency system based on the received PIN. If the application determines that the user device is indeed permitted to pre-authenticate based on the PIN, the application may transmit another prompt to the user device (e.g., via the RTP stream), which may signal to the user to enter a requested pre-authentication duration. The requested pre-authentication duration may be an amount of time, such as, for example, a number of hours, days, weeks, etc., during which the user is requesting to use the user device based on the current PIN authentication. For example, the user may enter the digits “30” via the user interface or native dialer of the user device, to request pre-authentication for 30 days. The user device may transmit these digits to the emergency system, and the application at the emergency system may identify these digits (in some cases, using an AI model) as the requested pre-authentication duration, and then determine whether the requested pre-authentication duration complies with the pre-authentication rules of the user account associated with the PIN. The application may then confirm or modify the requested pre-authentication duration to obtain the final pre-authentication duration for the user device. For example, when a pre-authentication rule of the user account indicates a maximum pre-authentication duration of 10 days for devices authenticated using the PIN, the application may set the final pre-authentication duration for the user device as 10 days (even though the user requested 30 days). Alternatively, when a pre-authentication rule of the user account indicates that there is no maximum pre-authentication duration set in association with the PIN, the application may set the final pre-authentication duration for the user device as the requested 30 days.

The application may then generate a pre-authentication key that is stored in association with the user device at the user account. The storage of the pre-authentication key with the user device at the user account may be programmed such that, when the pre-authentication duration expires, the pre-authentication key is removed from the user account (i.e., a self-expiring key). For example, the pre-authentication key may be a value, which may be based on or associated with the device identifier of the user device and the pre-authentication duration. The application may be programmed to recognize the pre-authentication key as a value that represents pre-authentication of the user device, such that the user device need not provide a PIN during the pre-authentication duration to access the services provided by the emergency system. For example, when the user device calls the access number during the pre-authentication duration, the emergency system may identify the pre-authentication key stored in association with the device identifier of the user device, and immediately prompt the user device for the destination number, bypassing the PIN authentication during the pre-authentication duration.

In some cases, the system may also include one or more external systems, that may collect environment and/or emergency data describing the locations of different types of emergency situations or events - for example, naturally occurring disasters (e.g., hurricanes, tornadoes, earthquakes, etc.) or man-made disasters (e.g., large-scale accidents, fires, explosions, etc.). This data may be used by the application at the emergency system using an AI model to identify patterns and trends that may be used to predict geographic areas (or geofences) in which an emergency situation is occurring. The application may then determine the cell sites that are within the geographic areas associated with the emergency situations (e.g., using a data store indicating Global Positioning System (GPS) coordinates of cell sites accessible by the emergency system).

The application may generate location-based pre-authentication rules based on the geographic areas and identified cell sites within the geographic areas. The location-based pre-authentication rules may define geographic areas (and/or the corresponding cell sites), in which user devices identified as being located in the geographic areas (or served by the cell sites) may be authenticated automatically (e.g., the application at the emergency system may not request a PIN for authentication). In this way, user devices within the geographic areas defined by the location-based pre-authentication rules may be pre-authenticated automatically solely based on the location of the user device, without the user requesting pre-authentication.

The embodiments disclosed herein are technically advantageous in many aspects, including, for example, reducing call setup time and call complexity during call completion using emergency telecommunications services. The embodiments disclosed herein also provide for increased security for these services by in some cases removing the potential for hacking or misuse of the PIN that would otherwise have to be manually entered repeatedly for multiple calls placed during an emergency situation, or sent over an insecure RTP stream to the emergency system. Therefore, in general, the embodiments disclosed herein also serve to increase system capacity by decreasing human errors and increasing call efficiency.

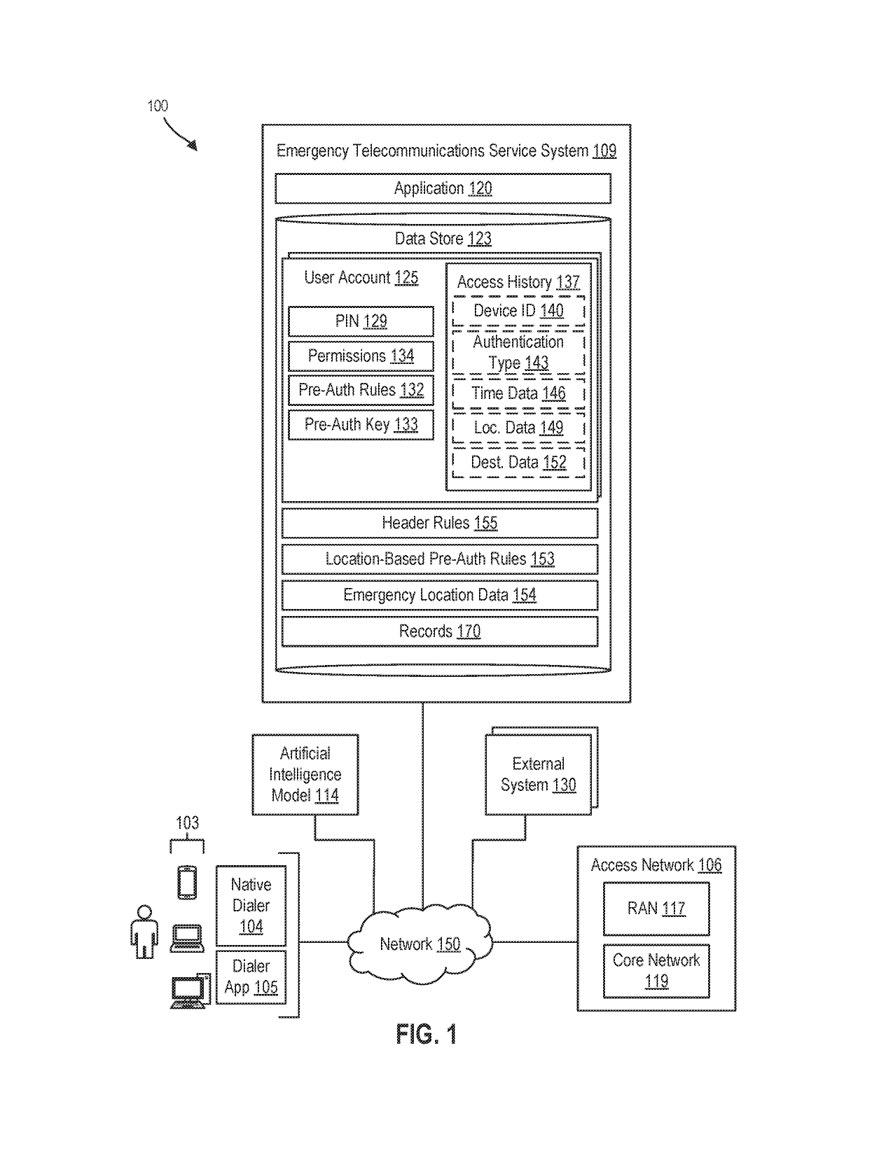

Turning now to FIG. 1, a communication network 100 is described. The communication network 100 includes one or more user devices 103 (sometimes referred to herein in the singular as “user device 103”), an access network 106, an emergency telecommunications service system 109 (e.g., sometimes referred to herein as “emergency system 109”), an artificial intelligence (AI) model 114, one or more external systems 130, and network 150. Network 150 may be one or more private networks, one or more public networks, or a combination thereof, interconnecting the user devices 103, access network 106, emergency telecommunications service system 109, AI model 114, and external systems 130. While FIG. 1 illustrates the access network 106, emergency telecommunications service system 109, AI model 114, and external systems 130 as being separate from the network 150, it should be appreciated that in some embodiments, the access network 106, emergency telecommunications service system 109, AI model 114, and external systems 130 may be part of the network 150. While FIG. 1 illustrates the AI model 114 as being separate from the emergency telecommunications service system 109 and voice verification system 112, it should be appreciated that in some embodiments, the AI model 114 may be included as part of the emergency telecommunications service system 109 and/or the voice verification system 112.

The user devices 103 may be devices, such as, for example, user equipment (UE), cell phone, a mobile phone, a smart phone, a tablet computer, a landline phone, a satellite phone, a public payphone, a government communication system, a voice over internet protocol (VoIP) phone, a laptop, a personal computer, or any other type of communication device. In an embodiment, the user device 103 may directly or indirectly connect to a public switched telephone network (PSTN) (e.g., indirectly connected when the user device 103 connects to a cell site, and the cell site connects to the PSTN). Each of the user devices 103 may be operated by an emergency personnel (also referred to herein as a “user”) that is registered with the emergency telecommunications service system 109. Each of the user devices 103 may not necessarily be owned by the user, but instead may simply be operated by the user as described herein. For example, the user device 103 may be a public payphone, or a cell phone owned by a friend of the user that the user is borrowing to make an emergency call. As described herein, the user device 103 may be any type of communication device that is capable of calling an access number associated with the access network 106.

The user devices 103 may each include a native dialer 104 and a dialer application 105. The native dialer 104 may be a default application of the user device 103 that manages the core calling functionalities of the user devices 103, allowing users to make and receive different types of calls directly from the main interface of the native dialer 104. The dialer application 105 may be a software application package programmed at the user devices 103 to simplify the process for authorized users to access the emergency telecommunications service system 109, by providing a user-friendly interface to automate accessing and authenticating with the emergency system. The dialer application 105 may present user interfaces on a display of the user device 103, such that the user may enter or select information via the user interface. The dialer application 105 may also have settings which may be configured or modified for various purposes (e.g., to provision the PIN 129, access number, and other verification credentials). In some cases, the native dialer 104 and dialer application 105 may be installed and stored in different memory partitions of the user device 103. For example, the native dialer 104 may be installed in a system area of a non-transitory memory of the user device 103 (e.g., by an original equipment manager (OEM) of the user device 103). Meanwhile, the dialer application 105 may be installed in a user area of the non-transitory memory of the user device 103 after the user device 103 has been distributed by the OEM or another retailer. It should be appreciated that the system area in the memory of the user device 103 contains the operating system and a limited number of authorized applications such as a browser application, the native dialer application, and some privileged other applications. Users may not be permitted to load applications into the system memory or otherwise change the system memory, users may only be permitted to load applications (e.g., the dialer application) into the user area of the memory. The user devices 103 may include other software applications and hardware components (e.g., speaker, microphone, processor, memory, etc.) that may be used to perform the methods disclosed herein.

The user devices 103 may be connected to the network 150 using a wired or wireless communication link (e.g., using a local area network or a base station, and communicating to the network 115 via a cellular or WiFi connection). For example, the user devices 103 may communicate with the network 115 according to a 5G, a long term evolution (LTE), a code division multiple access (CDMA), or a global system for mobile communications (GSM) wireless telecommunication protocol.

The access network 106 may be a telecommunications access network owned and operated by a telecommunications service provider. The access network 106 may leverage the infrastructure of PSTN and other communication networks. The access network 106 may include a radio access network (RAN) 117, a core network 119, and other network elements (e.g., routers, switches, gateways, bridges, virtual private networks (VPNs), virtual functions, etc.). The RAN 117 may facilitate wireless communication and may include various network elements, such as, for example, cell towers and base stations. The RAN 117 may allow authorized users to connect to the services using the user devices 103, providing flexibility and coverage in various locations. The core network 119 may handle the processing, routing, and management of the emergency communications, ensuring prioritized access for authorized users during emergencies.

In some cases, the RAN 117 is used by the emergency telecommunications service system 109 to provide prioritized access for registered users that have authenticated with the emergency telecommunications service system 109, using the authentication methods described herein. For example, prioritized access may ensure that communications initiated by the users are given precedence over non-priority communications and may not be hindered by network congestion. As described herein, once a user is authenticated with the emergency telecommunications service system 109, the user may request a connection (e.g., a call) to a destination phone number, by sending a SIP invite, as further described herein. If the connection is permitted, the emergency telecommunications service system 109 may complete the requested connection between the user device 103 by performing various prioritizing actions. For example, the emergency telecommunications service system 109 may complete the requested connection from the user device by dropping an on-going call of a non-emergency personnel to make a radio communication link in the RAN 117 available for the connection. As another example, the emergency telecommunications service system 109 may complete the requested connection from the user device by granting prioritized access to limited radio communication links in the RAN 117 to the user device 103.

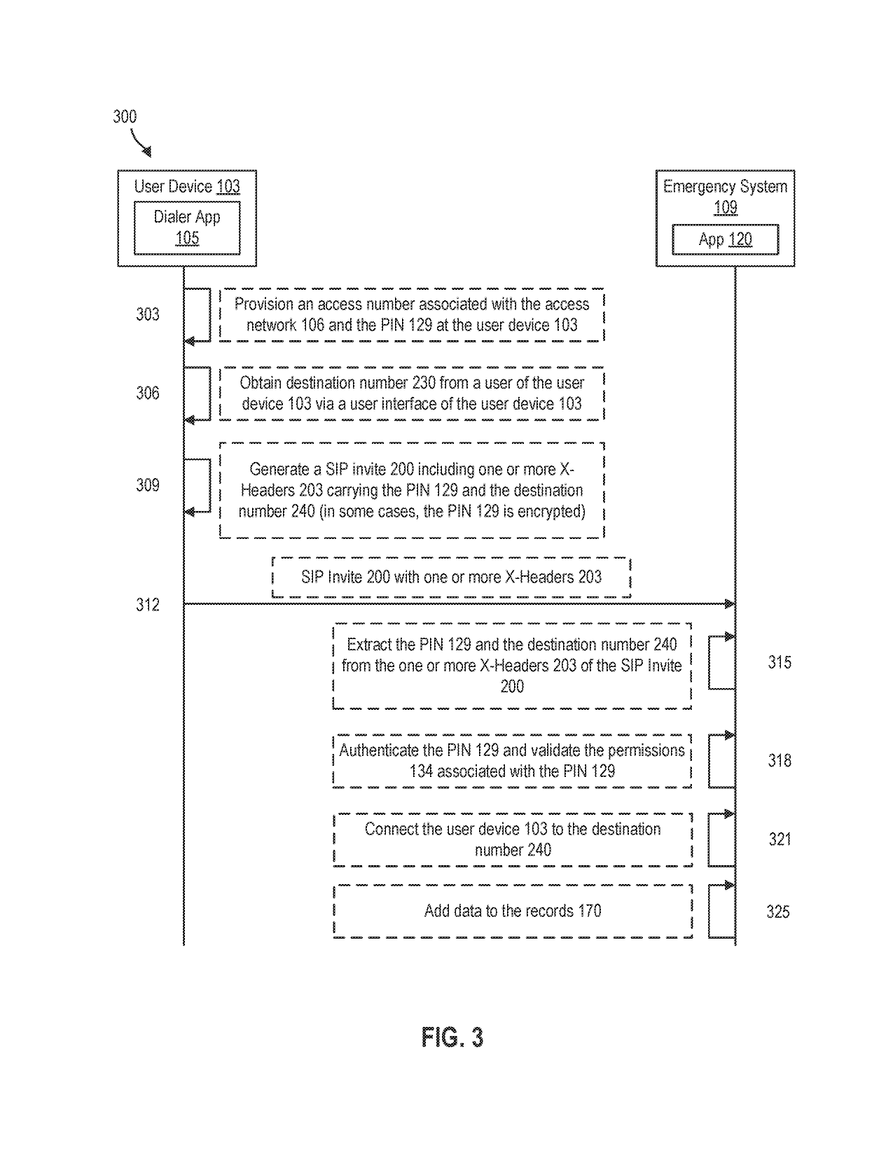

The emergency telecommunications service system 109 (also referred to herein as the “emergency system 109” or “GETS system 109”) may be a computer system, server software/hardware, or a collection of processors, memories, and/or networking resources used to perform authenticate requests received from the user devices 103 and connect user devices 103 with destinations when permitted. The emergency system 109 may include an application 120, which may include instructions stored in a memory of the emergency system 109 that when executed by a processor of the emergency system 109, may cause the application 120 to perform various steps as disclosed herein. For example, the application 120 may perform the steps of methods 300, 400, 500, 600, 700, 800, 900, and 1000 of FIGS. 3, 4, 5, 6, 7, 8, 9 and 10, respectively, as further described below.

The emergency system 109 may further include a data store 123. The data store 123 may include one or more memories located together or in a distributed manner. The data store 123 may store a user account 125 for one or more users that have completed the application and eligibility credentialing processes to receive a PIN 129 that may be used to authorize access to the emergency telecommunications services provided by the emergency system 109. The user account 125 may include the value of the PIN 129, one or more permissions 134 associated with the user of the PIN 129, one or more pre-authentication rules 132 associated with the PIN 129, one or more pre-authentication keys 133 associated with the PIN 129, and an access history 137 associated with the user of the PIN 129. As mentioned above, the PIN 129 may refer to a series of alphanumeric digits that have been uniquely assigned to an authenticated/registered user of the emergency system 109. The PIN 129 may also refer to other types of verification criteria that the emergency system 109 may use to authenticate users with valid user accounts 125. For example, the PIN 129 may refer to verification criteria such as a voice recording of the user speaking the PIN, a voiceprint (e.g., a voice recording of the user speaking a passphrase/abbreviated PIN or phrase), a facial scan image, a fingerprint image, or any other form of data (e.g., string of characters, image, recording, signal, etc.) that may be used to authenticate a user device 103 requesting services from the emergency system 109.

The permissions 134 may indicate actions (e.g., calls or types of calls) that the user may complete or may be prohibited from completing using the prioritized access provided by the emergency telecommunications services. The pre-authentication rules 132 may include conditions or logic related to the pre-authentication of a user device 103 based on the PIN 129 of the user account 125 (e.g., whether the user device 103 is or certain types of user devices 103 are permitted to pre-authenticate, and if so, a maximum pre-authentication duration). The pre-authentication key 133 may be a value, which may be arbitrary or based on the device identifier 140 of the user device 103 and/or a pre-authentication duration. The pre-authentication key 133 may be stored in association with a device identifier 140 of the user device 103 in the user account 125 for the pre-authentication duration. The pre-authentication key 133 may be removed from the user account 125 when the pre-authentication duration terminates, such that the pre-authentication key 133 is a self-expiring key that expires after the pre-authentication duration.

The access history 137 may maintain on-going data describing each event occurring between a user device 103 of the user and the emergency system 109. For example, the access history 137 may include device identifiers 140 (e.g., ANIs, MSISDNs, etc.) of the user devices 103 that have authenticated with the emergency system 109 using the PIN 129, the authentication type 143 performed by each user device 103 (e.g., PIN-based verification or voice verification), time data 146 describing the times that the user device 103 has called the emergency system 109 or that the emergency system 109 has prompted the user device 103 (e.g., for voice verification registration, for the PIN, for the destination, etc.), location data 149 describing the locations (e.g., geographical locations, serving cell site/towers, etc.) of the user devices 103 authenticating with the emergency system 109 or being prompted by the emergency system 109, destination data 152 identifying destination phone numbers that have been requested by the user devices 103 and/or for which a call has been completed. In some cases, the application 120 may collect this data upon the occurrence of each event (e.g., interaction between the user devices 103 and the emergency system 109 or task performed by the emergency system 109) and add the data to the access history 137 in the user account 125.

The data store 123 may also include header rules 155, location-based pre-authentication rules 153, emergency location data 154, and records 170 related to the authentication and calls completed using the emergency system 109. The header rules 155 may include logic, code, and/or conditions, which the application 120 may be programmed to implement, when a SIP invite including X-headers is received at the emergency system 109. For example, the header rules 155 may instruct application 120 to inspect SIP invites to determine whether an X-header is included in the SIP invite and to extract a PIN 129 (and in some cases, a destination number) from the X-header. The header rules 155 may also instruct the application 120 to add data describing attributes of the received call/SIP invite (e.g., whether the call originated from a dialer application 105 or a native dialer 104, a time of the call, a device identifier 140 of the caller user device 103, whether the PIN 129 passed or failed authentication, whether the requested call was completed, whether another call is requested, etc.) in a record 170 related to the call. To this end, the record 170 may include the data describing the aforementioned attributes of the received call/SIP invite, in the form of an entry in a database. The data may be stored in association with an identifier of the received call/SIP invite, and may include other data that may be stored in a call detail record of a received call/SIP invite.

The emergency location data 154 may be received from the external systems 130, and may include location data associated with various emergency situations and events occurring in the nation. For example, the emergency situations may refer to naturally occurring disasters (e.g., hurricanes, tornadoes, earthquakes, etc.) or man-made disasters (e.g., large-scale accidents, fires, explosions, etc.). The emergency location data 154 may include GPS coordinates of the emergency situations (which may be obtained from various sources).

The application 120 may receive the emergency location data 154 and use the AI model 114 to determine a geographic area (or geofence), or a geographic bounding box defined by GPS coordinate ranges, within which an emergency situation may be occurring. The geographic area may also be defined by a geohash. A geohash is a value or a compact string representation of a geographic location, encoding latitude and longitude into a short alphanumeric sequence. It divides the world into a grid of cells, each represented by a unique geohash, with longer strings providing more precise locations. The longer the geohash value (e.g., the more digits in the string), the more precisely a region associated with the geohash is identified. The application 120 may generate the location-based pre-authentication rules 153 based on the determined geographic area. The location-based pre-authentication rules 153 may include conditions or logic indicating that user devices 103 located in the determined geographic area and calling the emergency system 109 may be automatically authenticated (e.g., the user device 103 may not have to provide a PIN 129 to receive the prioritized network services). The location-based pre-authentication rules 153 may also define cell sites (or locations of cell sites) that are in the determined geographic area, such that when a user device 103 is served by one of the cell sites, the user device 103 may be automatically authenticated.

The AI model 114 may be a computer system (e.g., including both software and hardware components) designed to make predictions or forecasts based on patterns or trends learned from historical data (e.g., access histories 137). The AI model 114 may be implemented using software (e.g., algorithms, logic, and code) stored across memories. The host of the AI model 114 (which may be an external server or the emergency system 109) may provide the computational resources for execution of the AI model 114. AI model 114 may be implemented as one or more different types of models using, for example, linear regression, decision trees, support vector machines, neural networks, or ensemble methods. The AI model 114 may be a machine learning model, deep learning model, neural networking model, natural language processing (NLP) model, or any other type of AI model. It should be appreciated that any type of AI/predictive model may be used, and the underlying algorithms, computations, and machine learning libraries used by the AI model 114 should not be limited herein. The AI model 114 may be trained using the access histories 137 of different users, voice passphrases and voiceprints from different users, location-based data from different external sources, and other known data, such that the data points and algorithms in the AI model 114 may be used to identify patterns/trends as needed.

The external systems 130 may each be a computer system (e.g., including both software and hardware components) that may gather data associated with emergency situations, and in some cases, extract location data that may be used to identify the locations of the emergency situations. The location data may include GPS coordinates, a range of GPS coordinates, and/or a geohash associated with the emergency situation, and be transmitted to the emergency system 109 as the emergency location data 154.

Referring now to FIGS. 2A and 2B, shown are diagrams illustrating messages 200 and 250 that are forwarded through the communication network 100 of FIG. 1 according to various embodiments of the disclosure. Specifically, FIG. 2A illustrates a message 200, specifically a SIP invite 200 including one X-header 203, and FIG. 2B illustrates a message 250, specifically a SIP invite 250 including multiple X-headers 203A-B.

Referring now specifically to FIG. 2A, shown is a SIP invite 200, which may carry information used to establish and maintain SIP sessions in the communication network 100 of FIG. 1. The SIP invite 200 includes a message body 209, standard headers 206, and an X-header 203. The message body 209 may carry the content or payload that is related to the session being established or modified (e.g., the data used to set up the connection). As shown in FIG. 2A, the message body 209 may carry the session parameters 248 used to establish and maintain a session between the caller user device 103 and the emergency system 109. The session parameters 248 may include media types (e.g., types of media streams that may be used during the session, RTP audio stream, User Datagram Protocol (UDP) data stream, signaling stream, etc.), codec information (e.g., codecs supported by the caller user device for encoding and decoding the audio stream), a transport protocol (e.g., to be used for the RTP stream or UDP stream), addresses and port numbers where streams are to be sent, bandwidth parameters (e.g., bandwidth required for a session), etc.

The standard headers 206 may carry the essential information about the data session, the participants, and how the SIP invite 200 is to be handled. For example, the standard headers 206 may include, a “From” header identifying the originator of the SIP invite 200 (e.g., a device identifier 140 of the caller user device 103), a “To” header specifying the intended recipient of the SIP invite 200 (e.g., the access number used to access the emergency system 109), and other baseline headers included in SIP invites (e.g., a “Call-ID” header, a “CSeq” header, a “Via” header, a “Contact” header, a “Content-Type” header, “P-Access-Network-Info” header, etc.). As shown in FIG. 2A, the standard headers 206 may carry the device identifier 140 of the caller user device 103 (e.g., in the “From” header). The standard headers 206 may also carry a cell site location 240, or an identifier or location of a cell site associated with the access network 106 serving the caller user device 103. For example, the cell site location 240 may be carried in the P-Access-Network-Info header of the standard headers 206. The standard headers 206 may also carry the access number 245 associated with the access network 106 and used to access the emergency system 109 (e.g., in the “To” header).

The X-header 203 is an optional header that may be added to the SIP invite 200 to carry additional information not categorized as one of the standard headers 206. The information carried in the X-header 203 may be ignored by network elements and applications on the path between the caller user device 103 and the emergency system 109 that do not use the information carried in the X-header 203. As shown in FIG. 2A, the X-header 203 may carry the PIN 129 and the destination number 230. Although it should be appreciated that in some embodiments, the X-header 203 may only carry the PIN 129 (i.e., may not include the destination number 230).

As mentioned above, the user of the caller user device 103 may pre-provision the PIN 129 into the dialer application 105, and the user may also dial, select, or otherwise enter the destination number 230 via the dialer application 105. In some embodiments, the dialer application 105 may encrypt the PIN 129 prior to adding the PIN 129 to the X-header 203. For example, the dialer application 105 may be programmed to encrypt the PIN 129 according to a predefined encryption algorithm using one or more keys (e.g., which may be based on a hash of the device identifier 140 of the user device 103). As further described herein, the dialer application 105 may transmit the SIP invite 200 to the emergency system 109, and the emergency system 109 may extract the PIN 129 and the destination number 230 from the X-header 203.

Referring now to FIG. 2B, shown is a SIP invite 250, which is similar to the SIP invite 200 of FIG. 2A, in that the SIP invite 250 of FIG. 2B includes the message body 209 with session parameters 248, and the headers 206 with the device identifier 140 of the caller user device 103, the cell site location 240, and the access number 245. However, unlike the SIP invite 200 of FIG. 2A, the SIP invite 250 of FIG. 2B includes multiple X-headers 203A-B.

As shown in FIG. 2B, the SIP invite 250 includes a first X-header 203A carrying the PIN 129, which may be encrypted as described above. The SIP invite 250 also includes a second X-header 203B carrying the destination number 230. The dialer application 105 may transmit the the SIP invite 250 to the emergency system 109, and the emergency system 109 may extract the PIN 129 from the X-header 203A and extract the destination number 230 from the X-header 203B. In this way, the SIP invite 200 and 250 may include any number of X-headers 203A-B, carrying different types of information that may be relevant to authenticating the user operating the user device 103 with the emergency system 109, and establishing a session between the user device 103 and the emergency system 109.

Referring now to FIG. 3, shown is a message sequence diagram illustrating a method 300 of providing optimized and prioritized telecommunication services to a user device 103 based on the SIP invites 200 and 250 (hereinafter referred to as “SIP invite 200”) of FIGS. 2A-B. Method 300 may be performed by the dialer application 105 at the user device 103 and the application 120 at the emergency system 109.

At operation 303, the dialer application 105 may provision an access number 245 associated with the access network 106 at the user device 103, such that when the dialer application 105 calls the access number 245, the user device 103 initiates a session with the emergency system 109. For example, the user may open the settings of the dialer application 105 via a user interface of the user device 103. The user may then select a telecommunication service provider via the user interface of the user device 103, and the selection may be associated with the access number 245 associated with the access network 106 of the telecommunications service provider. At operation 303, the dialer application 105 may also provision a PIN 129 at the user device 103. For example, the user may open the settings of the dialer application 105, and manually type in the PIN 129 via the user interface/using a physical keyboard of the user device 103, or speak the PIN 129 into a microphone of the user device 103.

At operation 306 (subsequent to operation 303 when the PIN 129 and access number 245 have been provisioned at the user device 103), the dialer application 105 may obtain a destination number 230 from the user of the user device 103 via the user interface. For example, the user may operate the user device 103 and open the dialer application 105 to enter a requested destination number 230 (e.g., by manually typing the digits of the destination number 230 into a touch keypad or physical keyboard of the user device 103 or speaking the digits of the destination number 230 into a microphone of the user device 103).

At operation 309, the dialer application 105 may call the access number 245, which may trigger generation of a SIP invite 200 (or any other message encoded in another format) including one or more X-headers 203 carrying the PIN 129 and the destination number 230. The term SIP invite 200 as used herein may refer to the call initiated by the user device 103. In an embodiment, the dialer application 105 may encrypt the PIN 129 prior to adding the PIN 129 into the X-header 203. The encryption may be performed, for example, using a predefined encryption algorithm and using a key (e.g., based on a hash of a device identifier 140 identifying the user device 103).

At operation 312, the dialer application 105 may transmit the SIP invite 200 with the one or more X-headers 203 to the application 120 at the emergency system 109 (e.g., via the data stream as opposed to the RTP audio stream). At operation 315, the application 120 at the emergency system 109 may extract the PIN 129 and the destination number 230 from the one or more X-headers 203 of the SIP invite 200. The application 120 may first decrypt the PIN 129 when the PIN 129 is encrypted. For example, the decryption may be performed, for example, using a predefined decryption algorithm (that corresponds with the aforementioned encryption algorithm) and using a key (e.g., based on a hash of a device identifier 140 identifying the user device 103, which may correspond to the key used for encryption).

At operation 318, the dialer application 105 may authenticate the PIN 129 to verify that the PIN 129 has been assigned to an authorized user of the emergency system 109 by, for example, determining whether the PIN 129 received in the X-header 203 matches a PIN 129 stored in a valid user account 125 at the data store 123 of the emergency system 109. When the PIN 129 received in the X-header 203 matches a PIN 129 stored in a valid user account 125 at the data store 123 of the emergency system 109, the PIN 129 received in the X-header 203 may be considered authenticated, such that the user device 103 is permitted to use the services provided by the emergency system 109. In this case, method 300 may proceed to operation 321, in which the application 120 establishes a call or connection between the user device 103 and the destination number 230. When the PIN 129 received in the X-header 203 does not match a PIN 129 stored in a valid user account 125 at the data store 123 of the emergency system 109, the PIN 129 received in the X-header 203 may have failed authentication, such that the user device 103 is not permitted to use (or prohibited from using) the services provided by the emergency system 109. In this case, the application 120 may respond with a call failure notification to the dialer application 105, indicating that authentication of the user device 103 has failed due to an invalid PIN 129 entry.

At operation 325, the application 120 may record data associated with the received SIP invite 200, the PIN 129, destination number 230, permissions 134, etc. into a record 170 associated with the SIP invite 200 or call received from the user device 103. For example, the application 120 may generate a record 170 associated with the call received from the user device 103 to request a connection to the destination number 230. The application 120 may add data to the record 170, which may include, for example, an identifier (e.g., value identifying) the call or the SIP invite 200 received at operation 312, the content of the SIP invite 200, a time of receiving the SIP invite 200, a location of the user device 103 when the SIP invite 200 was received, the PIN 129 received from the user device 103, the device identifier 140 of the user device 103, the requested destination number 230, the associated permissions 134 analyzed at operation 318, whether the PIN 129 was successfully authenticated or not, whether the call was completed between the user device 103 and the destination number 230, etc. In an embodiment, the application 120 may also use the AI model 114 to identify patterns and trends stored in the records 170, to perform error detections, predict anomalies in the types and nature of the received requests, detection of bot dialers, detection of denial of service attempts, etc. The application 120 may also use the records 170 to determine various metrics, which may be used to optimize the system and/or generate reports that may be sent to corporate/government entities for compliance purposes.

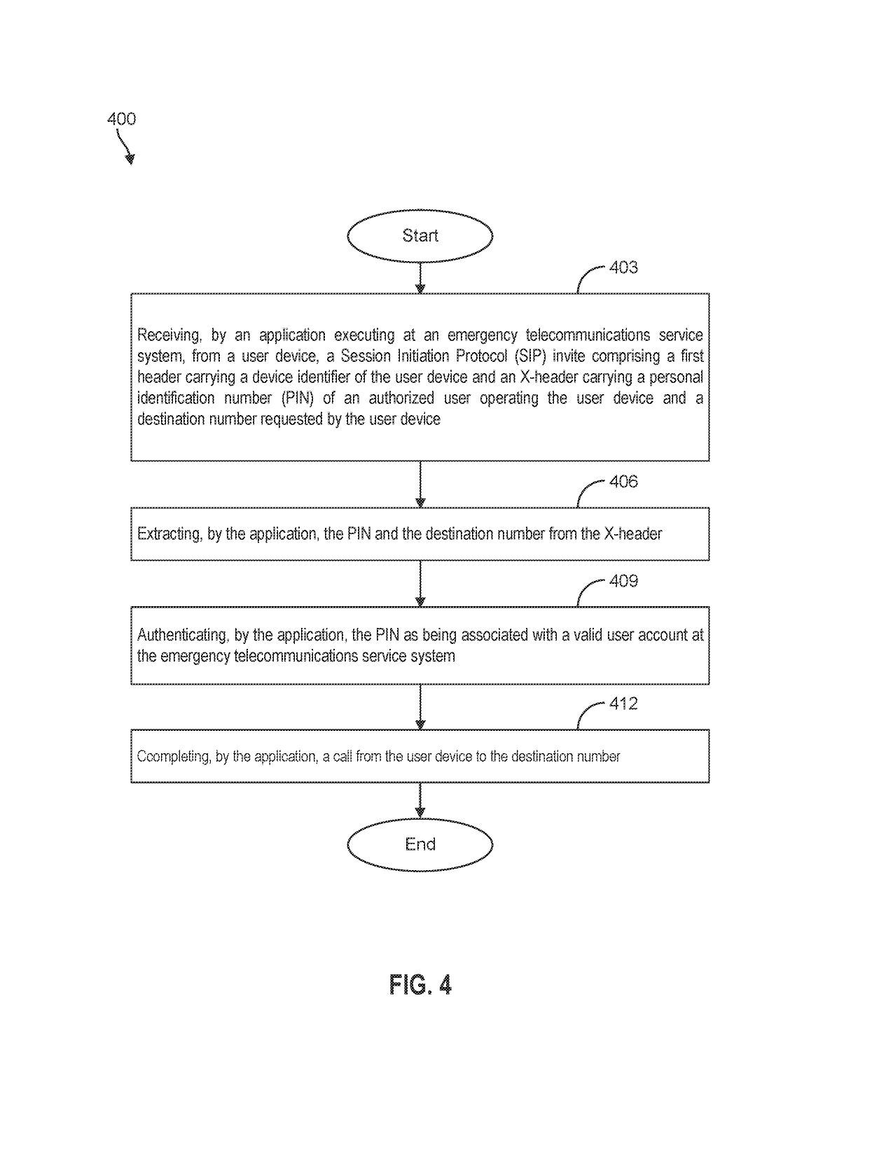

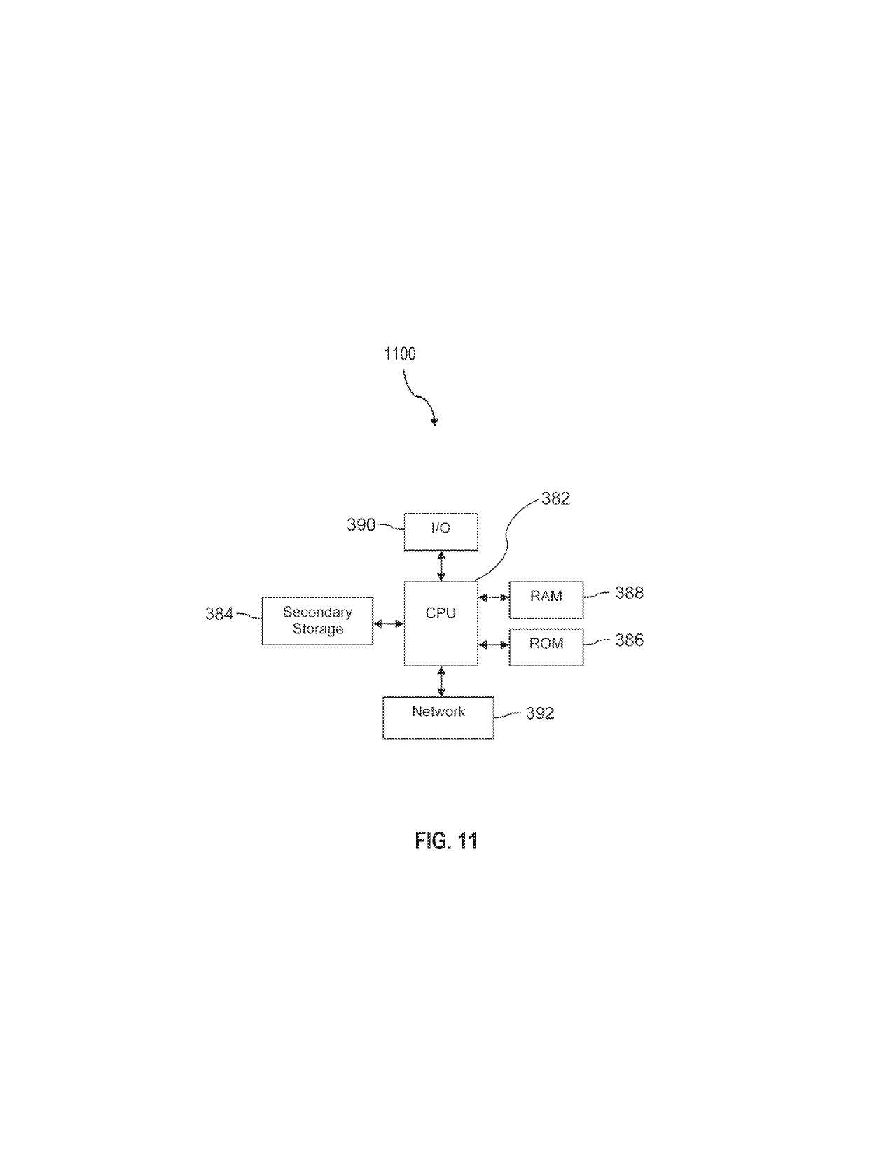

Referring now to FIG. 4, shown is a method 400 of providing optimized and prioritized telecommunication services to a user device 103 based on the SIP invite 200. Method 400 may be performed by the application 120 of the emergency system 109 and the dialer application 105 of the user device 103. In embodiments, the method 400 may be implemented using a computer system with components as shown in FIG. 11. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order. In the embodiment of method 400, the emergency system 109 provides GETS.

At step 403, method 400 comprises receiving, by an application 120 executing at an emergency telecommunications service system 109, from a user device 103, a SIP invite 200 comprising a first header 206 carrying a device identifier 140 of the user device 103 and an X-header 203 carrying a PIN 129 of an authorized user operating the user device 103 and a destination number 230 requested by the user device 103. At step 406, method 400 comprises extracting, by the application 120, the PIN 129 and the destination number 230 from the X-header 203.

At step 409, method 400 comprises authenticating, by the application 120, the PIN 129 as being associated with a valid user account 125 at the emergency telecommunications service system 109. At step 412, method 400 comprises completing, by the application 120, a call from the user device 103 to the destination number 230. To complete the call, the application 120 may route the call through the public switched telephone network (PSTN) or a VoIP network, prioritizing the call over regular traffic. The application 120 ensures that the call is routed through network elements that recognize a high-priority status, reducing the likelihood of congestion blocking the call. The call is then connected to the destination number 230 as a standard call, with any necessary protocol conversions or signaling adjustments handled by the network to maintain the priority level throughout the call path.

Method 400 may include other steps and/or features that are not otherwise shown in FIG. 4. In an embodiment, the device identifier 140 of the user device 103 is an automatic number identification (ANI) or a mobile station international subscriber directory number (MSISDN) of the user device 103. In an embodiment, method 400 may further comprise decrypting, by the application 120, the PIN 129 using a decryption algorithm and a key after extracting the PIN 129 from the X-header 203. In an embodiment, the key is based on a hash of the device identifier 140.

In an embodiment, the SIP invite 200 further comprises a second header 206 carrying the cell site location 240 of a cell site serving the user device 103. In an embodiment, the valid user account 125 comprises a permission indicating whether the user device 103 is permitted to complete a call with the destination number 230. In an embodiment, method 400 comprises transmitting, by the application 120, a prompt to the user device 103 permitting the user device 103 to request another call. In an embodiment, the PIN 129 is a 12-digit numerical string.

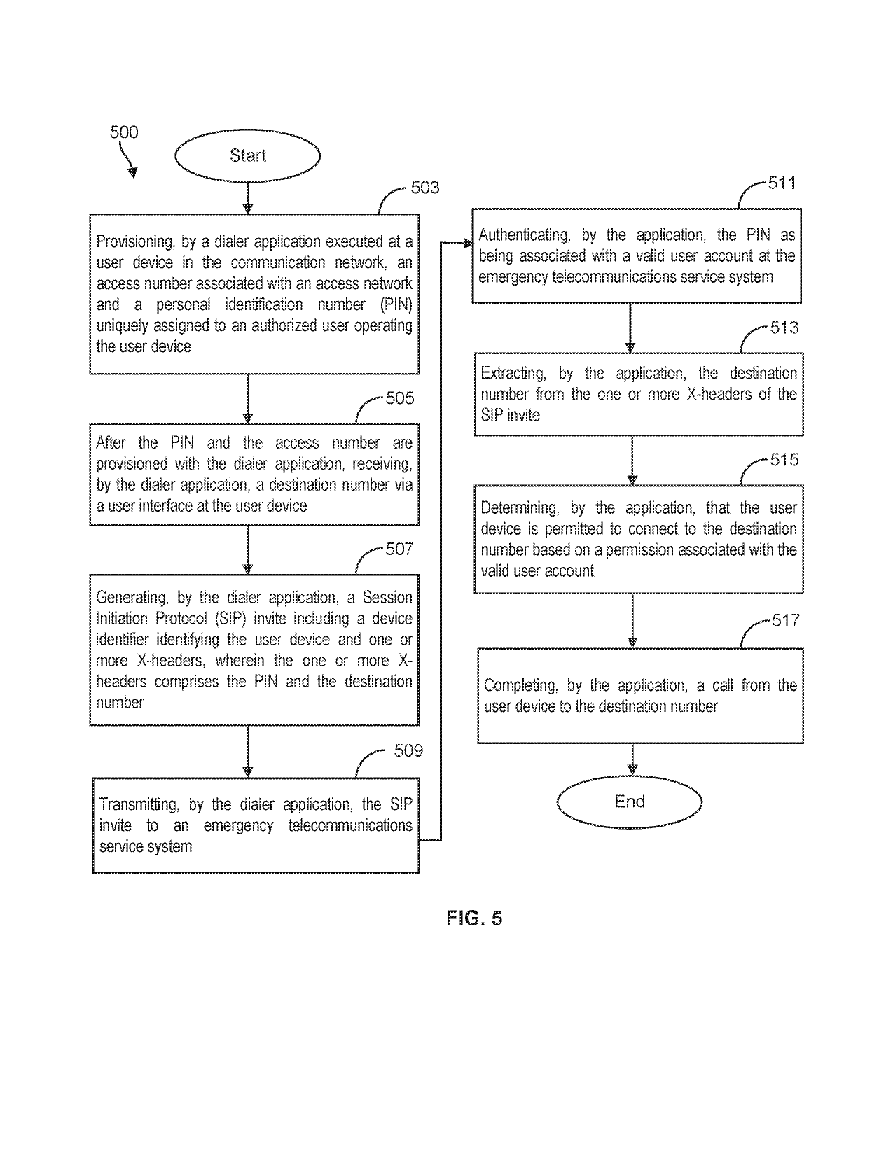

Referring now to FIG. 5, shown is a method 500 of providing optimized and prioritized telecommunication services to a user device 103 based on the SIP invite 200. Method 500 may be performed by the application 120 of the emergency system 109 and the dialer application 105 of the user device 103. In embodiments, the method 500 may be implemented using a computer system with components as shown in FIG. 11. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order. In the embodiment of method 500, the emergency system 109 provides GETS.

At step 503, method 500 comprises provisioning, by a dialer application 105 executed at a user device 103 in the communication network 100, an access number associated with an access network 106 and a PIN 129 uniquely assigned to an authorized user operating the user device 103. At step 505, method 500 comprises after the PIN 129 and the access number are provisioned with the dialer application 105, receiving, by the dialer application 105, a destination number 230 via a user interface at the user device 103. At step 507, method 500 comprises generating, by the dialer application 105, a SIP invite 200 including a device identifier 140 identifying the user device 103 and one or more X-headers 203. The one or more X-headers 203 comprises the PIN 129 and the destination number 230. At step 509, method 500 comprises transmitting, by the dialer application 105, the SIP invite 200 to an emergency telecommunications service system 109.

At step 511, method 500 comprises authenticating, by the application 120, the PIN 129 as being associated with a valid user account 125 at the emergency telecommunications service system 109. At step 513, method 500 comprises extracting, by an application 120 executed at the emergency telecommunications service system 109, the PIN 129 from the one or more X-headers 203 of the SIP invite 200. At step 515, method 500 comprises determining, by the application 120, that the user device 103 is permitted to connect to the destination number 230 based on a permission 134 associated with the valid user account 125. At step 517, method 500 comprises completing, by the application 120, a call from the user device 103 to the destination number 230.

Method 500 may include other steps and/or features that are not otherwise shown in FIG. 5. In an embodiment, method 500 may further comprise encrypting, by the dialer application 105, the PIN 129 based on a predefined encryption algorithm and a key prior to generating the SIP invite 200 including the PIN 129. In an embodiment, method 500 may further comprise decrypting, by the application 120, the PIN 129 based on a predefined encryption algorithm and the key after extracting the PIN 129 from the one or more X-headers 203 of the SIP invite 200.

In an embodiment, the device identifier 140 is carried in a “From” header 260 of the SIP invite 200. In an embodiment, the SIP invite 200 further comprises session parameters 248 governing a session between the user device 103 and the emergency telecommunications service system 109. In an embodiment, the SIP invite 200 further comprises a cell site location 240 indicating a location of a cell site serving the user device 103.

Referring now to FIG. 6, shown is a message sequence diagram illustrating a first method 600 of pre-authenticating user devices 103 operated by authorized personnel to use the emergency system 109 of FIG. 1. Method 600 may be performed by the user device 103 (e.g., the native dialer 104, dialer application 105, and/or other application) via one or more user interfaces at the user device 103. Method 600 may also be performed by the application 120 at the emergency system 109.

At operation 603, the user device 103 (e.g., a user operating the user device 103) dials or calls the access number 245 associated with the access network 106. For example, the user may open the native dialer 104 at the user device 103, and dial a predefined access number 245 that may be used to request a connection between the user device 103 and the emergency system 109. In another case, the user may also have the access number 245 saved as a contact, and may dial the access number 245 by selecting the contact via the user interface of the user device 103. In yet another case, the user may have dialed the access number 245 using the dialer application 105. In either case, the calling of the access number 245 may trigger the user device 103 to transmit a message (e.g., a SIP invite) carrying the device identifier 140 of the user device 103 and the access number 245 to the emergency system 109.

At operation 606, the application 120 at the emergency system 109 may receive the call (e.g., receive the SIP invite 200) from the user device 103, determine that the user device 103 is requesting the prioritized services offered by the emergency system 109, and transmit a prompt for a PIN 129. For example, the prompt may be transmitted as a DTMF tone (e.g., over the RTP audio stream), which may be audible at a speaker of the user device 103 when the user device 103 receives the DTMF tone.

The user may receive the prompt (e.g., listen to the tone playing at the speaker of the user device 103), and determine that the prompt is for the user to enter a valid PIN 129 at the user device 103 (e.g., via the user interface, a keypad, a microphone, or other device/component of the user device 103). The user may then enter the PIN 129 and a pre-authentication request indicator 610 via the user device 103 (e.g., via the user interface, a keypad, a microphone, or other device/component of the user device 103), in response to the single prompt received at operation 606. The pre-authentication request indicator 610 may be a value (e.g., in the form of alphanumeric digits, a voice passphrase, or another signal) indicating a request for pre-authentication. For example, the pre-authentication request indicator 610 may include a predefined string of digits or characters, or predefined voice passphrase, which may be transmitted to the emergency system 109 and interpreted as being a request for pre-authentication. For example, after manually typing the PIN 129 at the user device 103, the user may also type “# #” – in which the string # # constitutes the pre-authentication request indicator 610. As another example, the user may speak the phrase “pre-authenticate” into the microphone as the pre-authentication request indicator 610.

At operation 609, the user device 103 may transmit the PIN 129 and the pre-authentication request indicator 610 to the emergency system 109. In some cases, the pre-authentication request indicator 610 may be transmitted with the PIN 129 to the emergency system 109 via the RTP audio stream. In other cases, the pre-authentication request indicator 610 may be transmitted to the emergency system 109 over a different path/channel than the PIN 129 (e.g., one may be transmitted over the data stream (e.g., UDP stream) while the other is transmitted over the audio stream (e.g., RTP stream)).

At operation 612, the application 120 may extract the PIN 129 from the received stream and authentication the PIN 129. The application 120 may first identify the digits/passphrase of the PIN 129 (in some cases, using the AI model 114) and authenticate the PIN 129 by, for example, verifying that a matching PIN 129 with the same digits/passphrase is stored with a valid user account 125 at the emergency system 109. If so, the application 120 may extract then the pre-authentication request indicator 610 to determine that an authorized user is requesting to pre-authenticate the user device 103 with the emergency system 109.

At operation 615, the application 120 may determine whether pre-authentication is permitted for the user device 103 based on one or more pre-authentication rules 132 associated with the PIN 129 and/or the user device 103. First, the application 120 may obtain one or more pre-authentication rules 132 of the user account 125 having the PIN 129 received from the user device 103 in operation 609. The pre-authentication rules 132 may indicate conditions associated with pre-authenticating one or more user devices 103 based on the PIN 129. In some cases, the pre-authentication rules 132 may be based on user devices 103 that have a history of authenticating with the emergency system 109 using the received PIN 129 (e.g., the user device 103 has previously authenticated with the emergency system 109 using the PIN 129). In other cases, the pre-authentication rules 132 may be based on the PIN 129 received from the user device 103, regardless of whether the user device 103 has previously authenticated with the emergency system 109 using the PIN 129. For example, one pre-authentication rule 132 may indicate whether the user device 103 (and other user devices 103) authenticating with the PIN 129 is permitted to pre-authenticate, another pre-authentication rule 132 may indicate a maximum pre-authentication duration for the user device 103 (and other user devices 103) authenticating with the PIN 129, yet another pre-authentication rule 132 may indicate that different types of user devices 103 authenticating with the PIN 129 have different pre-authentication permissions and/or different maximum pre-authentication durations, etc.

In this case, the application 120 may first determine whether the user device 103 is permitted to pre-authenticate with the emergency system 109 based on the received PIN 129 using a first pre-authentication rule 132. The first pre-authentication rule 132 may indicate whether or not the user device 103 (or the type of user device 103) is permitted to pre-authenticate with the emergency system 109. The determination of whether the user device 103 is permitted to pre-authenticate may be based on various factors (e.g., time of day, type of user device 103, location of the user device 103, etc.). For example, a pre-authentication rule 132 may indicate that landlines are permitted to pre-authenticate using the PIN 129, but cell phones are not permitted to pre-authenticate using the PIN 129.

In the example shown in method 600, it may be determined that the user device 103 is permitted to pre-authenticate with the emergency system 109. At operation 618, the application 120 may transmit a prompt for a requested pre-authentication duration 621. For example, the requested pre-authentication duration 621 may be for 30 days (or any other number of minutes, hours, days, weeks, or even months). For example, the prompt may be transmitted as a DTMF tone (e.g., over the RTP audio stream), which may be audible at a speaker of the user device 103.

The user may receive the prompt (e.g., listen to the tone playing at the speaker of the user device 103), and determine that the prompt is for the user to enter the requested pre-authentication duration 621 (e.g., via the user interface, a keypad, a microphone, or other device/component of the user device 103). The user may then enter the requested pre-authentication duration 621 via the user device 103 (e.g., via the user interface, a keypad, a microphone, or other device/component of the user device 103). At operation 624, the user device 103 may transmit the pre-authentication duration 621 (e.g., the digits “3 0”) to the emergency system 109 (via the audio stream (e.g., RTP stream) or the data stream (e.g., UDP stream).

The application 120 at the emergency system 109 may receive the pre-authentication duration 621 (in either the audio stream or data stream), and determine the duration of time requested for pre-authentication based on the received pre-authentication duration 621. For example, when the digits “30” are received as the pre-authentication duration 621, the application 120 may determine that the user is requesting a 30-day pre-authentication duration 621 for the user device 103. Similarly, when the user speaks the number “30” into the microphone of the user device 103, and the application 120 receives the spoken “30” from the user device 103, the application 120 may determine, using the AI model 114, that the user is requesting a 30-day pre-authentication duration 621 for the user device 103.

At operation 627, the application 120 may validate or modify the requested pre-authentication duration 621 to obtain a final pre-authentication duration 630 for the PIN 129 in association with the user device 103 based on one or more pre-authentication rules 132 associated with the PIN 129 and/or user device 103. For example, a pre-authentication rule 132 for the PIN 129 may indicate that any user device 103 authenticating with the PIN 129 may pre-authenticate for a maximum of 15 days. In this case, since the requested pre-authentication duration 621 (30 days) is greater than the maximum pre-authentication duration (15 days) as indicated in the pre-authentication rule 132, the application 120 may modify the requested pre-authentication duration 621 to comply with the pre-authentication rule 132, by setting the final pre-authentication duration 630 to be the maximum pre-authentication duration (15 days) as indicated in the pre-authentication rule 132. As another example, a pre-authentication rule 132 for the PIN 129 may indicate that a user device 103 authenticating with the PIN 129 may pre-authenticate for any number of days (i.e., no maximum pre-authentication duration). In this case, the application 120 may set the final pre-authentication duration 630 to be the requested pre-authentication duration 621 (30 days).

At operation 633, the application may generate and store a pre-authentication key 133 in association with the PIN 129 and the device identifier 140 of the user device 103 (e.g., in the user account 125 at the data store 123). The pre-authentication key 133 may be any value that may be set to expire after the final pre-authentication duration 630. The storage of the pre-authentication key 133 with the device identifier 140 of the user device 103 at the user account 125 may be programmed such that, when the final pre-authentication duration 630 expires, the pre-authentication key 133 is removed from the user account 125 (i.e., a self-expiring key). In this way, the pre-authentication key 133 may be a value, which may be based on or associated with the device identifier 140 of the user device 103 and the final pre-authentication duration 630. The application 120 may be programmed to recognize the pre-authentication key 133 as a value that represents pre-authentication of the user device 103 with the PIN 129, such that the user device 103 need not provide a PIN 129 during the final pre-authentication duration 630 to access the services provided by the emergency system 109.

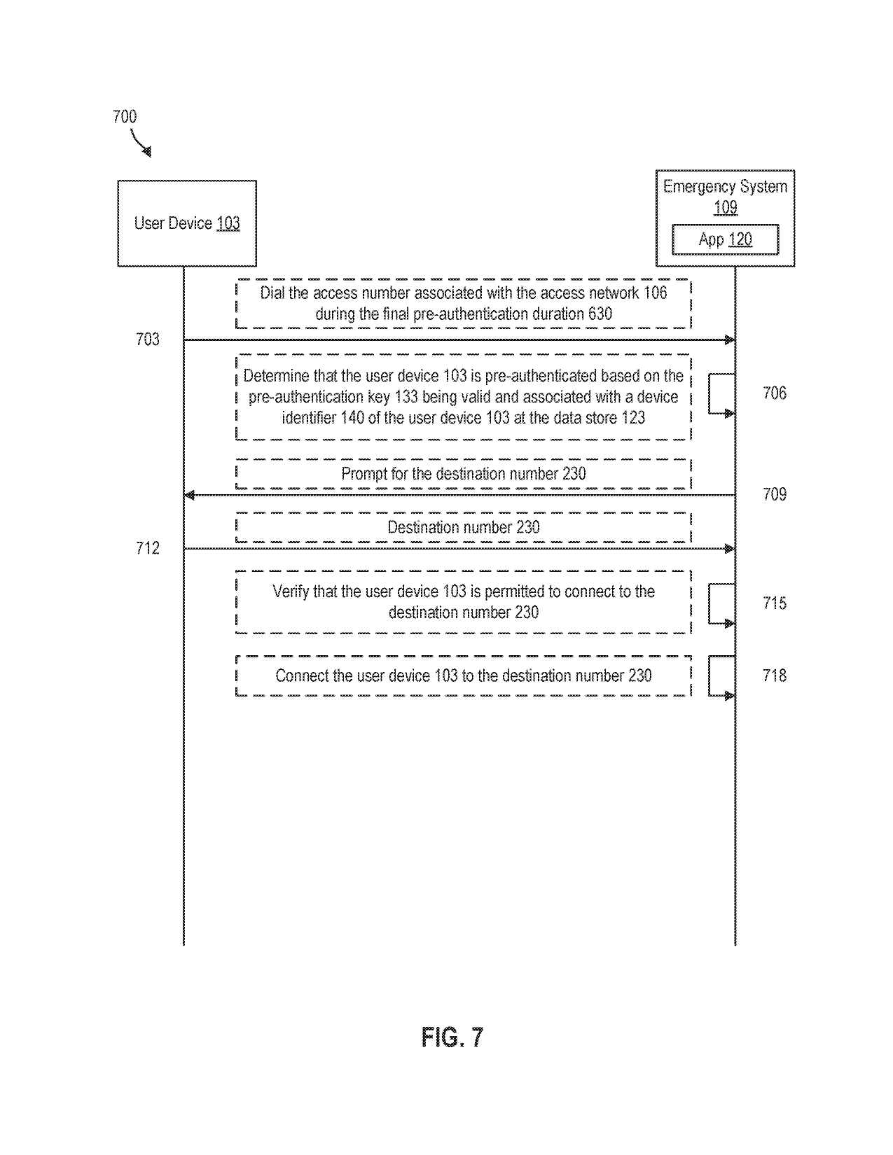

Referring now to FIG. 7, shown is a message sequence diagram illustrating a second method 700 of pre-authenticating user devices 103 operated by authorized personnel to use the emergency system 109 of FIG. 1. Specifically, method 700 may be performed after the pre-authentication key 133 has been stored in the user account 125 associated with the PIN 129. Method 700 may be performed by the user device 103 (e.g., the native dialer 104, dialer application 105, and/or other application) via one or more user interfaces at the user device 103. Method 700 may also be performed by the application 120 at the emergency system 109.

Subsequent to the user device 103 successfully pre-authenticating with the emergency system 109 and during the final pre-authentication duration 630, the user device 103 may perform operation 703. At operation 703, the user device 103 may dial/call the access number 245 associated with the access network 106. For example, the user may open the native dialer 104 at the user device 103, and dial a predefined access number 245 that may be used to request a connection between the user device 103 and the emergency system 109. In another case, the user may also have the access number 245 saved as a contact, and may dial the access number 245 by selecting the contact via the user interface of the user device 103. In yet another case, the user may have dialed the access number 245 using the dialer application 105. In either case, the calling of the access number 245 may trigger the user device 103 to transmit a message (e.g., a SIP invite 200) carrying the device identifier 140 of the user device 103 and the access number 245 to the emergency system 109.

The application 120 at the emergency system 109 may receive the call from the user device 103, and determine that the user device 103 is attempting to use the prioritized services offered by the emergency system 109. Instead of transmitting a prompt to the user device 103 for the PIN 129, the application 120 may perform operation 706. At operation 706, the application 120 may determine that the user device 103 is pre-authenticated with the PIN 129 (as described above with reference to method 600 of FIG. 6) based on the pre-authentication key 133 being valid and associated with a device identifier 140 of the user device 103 at the data store 123. For example, the application 120 may search user accounts 125 for a device identifier 140 associated with the calling user device 103, and determine whether a valid (e.g., non-expired) pre-authentication key 133 is stored in association with the device identifier 140 of the user device 103, in a valid user account 125 having a valid PIN 129.

When a valid pre-authentication key 133 is stored in association with the device identifier 140 of the user device 104, the application 120 may bypass PIN 129 authentication with the user device 103, and instead skip to operation 709, and transmit a prompt to the user device 103 for the destination number 230. In this way, the application 120 has determined that the user device 103 is authenticated to receive the services of the emergency system 109, even though the user device 103 did not provide a PIN 129 at the time of calling at operation 703. As mentioned above, the prompt may be transmitted as a DTMF tone (e.g., over the RTP or audio stream), which may be audible at a speaker of the user device 103 once the user device 103 receives the DTMF tone.

The user may receive the prompt (e.g., listen to the tone playing at the speaker of the user device 103), and determine that the prompt is for the user to enter a destination number 230 at the user device 103 (e.g., via the user interface, a keypad, a microphone, or other device/component of the user device 103). In some cases, an audio attribute (e.g., tone, pitch, volume, frequency, harmonic, etc.) for each of the different prompts (e.g., a prompt for the access number, a prompt for the PIN 129, and a prompt for the destination number 230) may be different, such that the user may immediately recognize the information being prompted (e.g., whether the prompt is for a PIN 129, requested pre-authentication duration 621, or destination number 230).

The user may then enter the destination number 230 into the user device 103 (e.g., via the user interface, a keypad, a microphone, or other device/component of the user device 103). For example, the user may enter the destination number 230 by speaking the digits into the microphone of the user device 103, selecting digits at the native dialer 104 or dialer application 105, or selecting a contact in a contact list of the user device 103. At operation 712, the user device 103 may transmit the destination number 230 to the emergency system 109 (e.g., via the audio stream as DTMF tones or via an X-header 203 of a SIP invite 200).

At operation 715, the application 120 may verify whether the user device 103 is permitted to connect to the destination number 230, based on the permissions 134 in the user account 125 (in which pre-authentication of the user device 103 and the pre-authentication key 133 is indicated). For example, when the destination number 230 is an international phone number, and the permissions 134 of the user account 125 indicate that international calls are not permitted, the application 120 may notify the user device 103 that the requested call is not permitted using the emergency system 109. In contrast, when the permissions 134 of the user account 125 indicate that international calls are permitted, the application 120 may perform operation 718 and connect the user device 103 to the destination number 230. To complete the call, the application 120 may route the call through the public switched telephone network (PSTN) or a VoIP network, prioritizing the call over regular traffic. The application 120 ensures that the call is routed through network elements that recognize a high-priority status, reducing the likelihood of congestion blocking the call. The call is then connected to the destination number 230 as a standard call, with any necessary protocol conversions or signaling adjustments handled by the network to maintain the priority level throughout the call path.

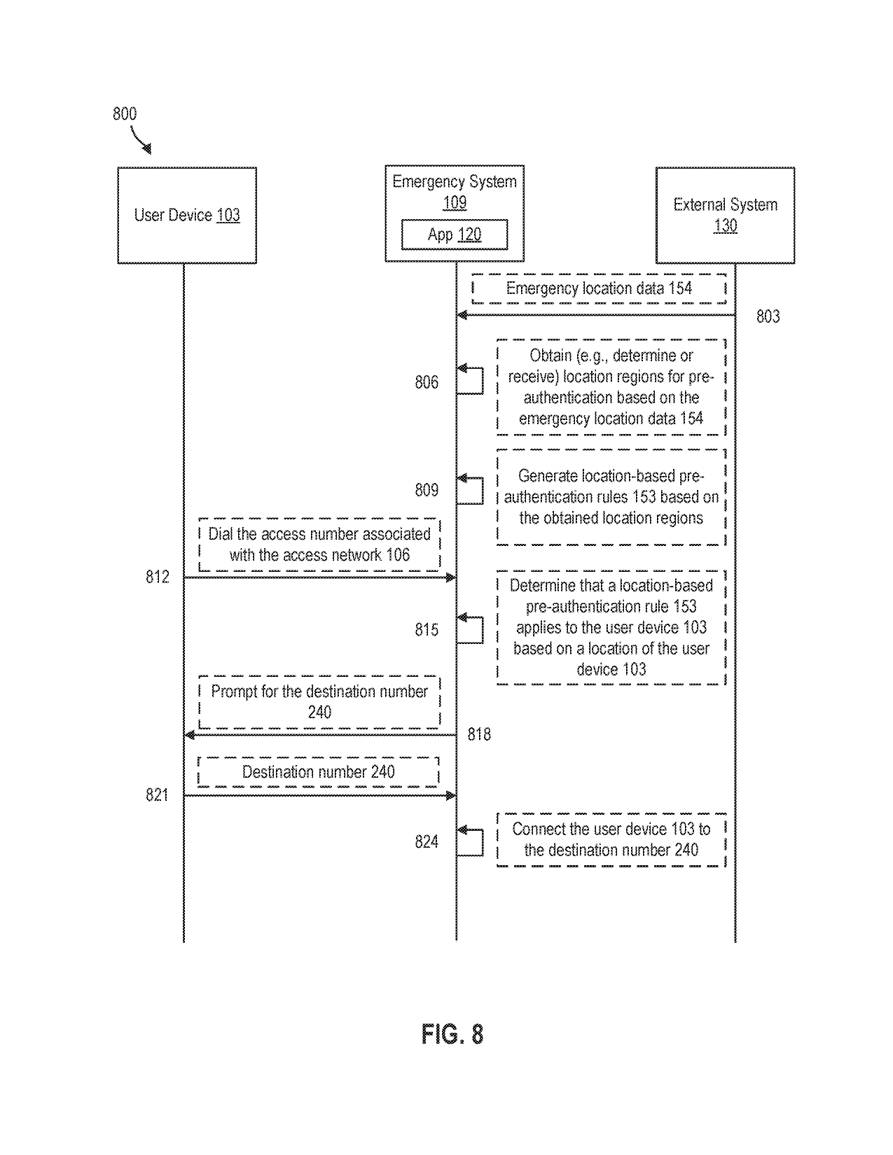

Referring now to FIG. 8, shown is a message sequence diagram illustrating a third method 800 of pre-authenticating user devices 103 operated by authorized personnel to use the emergency system 109 of FIG. 1. Method 800 may be performed by the user device 103 (e.g., the native dialer 104, dialer application 105, and/or other application) via one or more user interfaces at the user device 103. Method 800 may also be performed by the application 120 at the emergency system 109 and one or more external systems 130.

At operation 803, one or more external systems 130 may collect emergency location data 154 and transmit the emergency location data 154 to the emergency system 109. The emergency location data 154 may include environment and/or emergency data describing the locations of different types of emergency situations or events - for example, naturally occurring disasters (e.g., hurricanes, tornadoes, earthquakes, etc.) or man-made disasters (e.g., large-scale accidents, fires, explosions, etc.). The emergency location data 154 may include data describing one or more emergency situations, the actual locations of the emergency situations, and/or cell site locations 240 of cell sites that are serving the areas in which the emergency situations are occurring. The emergency location data 154 may also include non-location data describing one or more emergency situations, in which the non-location data may be used to infer a location of the emergency situation, in some cases, using the AI model 114. For example, emergency location data 154 may include transcripts of weather reports, social media postings relating to emergency situations, etc.

At operation 806, the application 120 at the emergency system 109 may obtain (e.g., determine/infer based on the emergency location data 154 or receive directly from the emergency location data 154) location regions for pre-authentication based on the emergency location data 154. For example, when the emergency location data 154 indicates an approaching or active hurricane in a metroplex based on weather reports, map data, and/or social media updates, the application 120 may use the AI model 114 to identify patterns and trends based on the weather reports, map data, and/or social media updates, to identify a GPS location region of the metroplex that may be or is currently being affected by the hurricane. In another case, when the emergency location data 154 indicates the GPS coordinates and/or cell site locations 240 of the metroplex, this data may be used as the GPS location region of the metroplex that may be or is currently being affected by the hurricane. The GPS location region of the metroplex that may be or is currently being affected by the hurricane may be considered the location region for pre-authentication.

At operation 809, the application 120 may generate location-based pre-authentication rules 153 based on the obtained location regions (identified in operation 806). The location-based pre-authentication rules 153 may define geographic areas (e.g., a bounding box or GPS coordinate ranges, a geohash value, etc.), in which user devices 103 identified as being located in the geographic areas may be authenticated automatically. In this case, the application 120 at the emergency system 109 may not request a PIN 129 for authentication. The location-based pre-authentication rules 153 may also define the cell sites having cell site locations 240 within the defined geographic areas, such that user devices 103 calling into the emergency system 109 that are being served by the identified cell sites may be authenticated automatically as well. The serving cell site and/or cell site locations 240 of cell sites may be indicated in the call (e.g., SIP invite 200) received from the user devices 103.

The location-based pre-authentication rules 153 may also define a final pre-authentication duration 630 for which user devices 103 within geographic areas or being served by certain cell sites are pre-authenticated with the emergency system 109. For example, a location-based pre-authentication rule may instruct that user devices 103 in the geographic area be automatically authenticated for a final pre-authentication duration 630 of 7 days. The final pre-authentication duration 630 may in some cases be determined using the AI model 114, based on historical data describing the duration of other, similar emergency situations. In this way, user devices 103 within the geographic areas defined by the location-based pre-authentication rules 153 may be pre-authenticated automatically solely based on the location of the user device 103, without the user requesting pre-authentication.

After the location-based pre-authentication rules 153 have been defined (and this may be an on-going, continuous process), a user device 103 in an identified geographic area may perform operation 812 and dial/call the access number associated with the access number (similar to operation 703 of method 700 of FIG. 7). At operation 815, after the application 120 receives the call from the user device 103, the application 120 may determine that a location-based pre-authentication rule 153 applies to the user device 103 based on a location of the user device 103. For example, the application 120 may identify a location of the user device 103 based on a header of the call (e.g., SIP invite 200) received at operation 812, and the location may be the actual location (e.g., GPS coordinates) of the user device 103 or the cell site location 240 (e.g., GPS coordinates) of the cell site serving the user device 103. The application 120 may determine that the location of the user device 103 corresponds to a geographic area defined in a location-based pre-authentication rule 153, and then bypass PIN 129 authentication for the user device 103.

Instead of transmitting a prompt to the user device 103 for the PIN 129, the application 120 may perform operation 818. At operation 818, the application 120 may transmit a prompt to the user device 103 for the destination number 230. In this way, the application 120 has determined that the user device 103 is authenticated to receive the services of the emergency system 109, even though the user device 103 did not provide a PIN 129 at the time of calling at operation 703. As mentioned above, the prompt may be transmitted as a DTMF tone (e.g., over the RTP audio stream), which may be audible at a speaker of the user device 103. The user may receive the prompt (e.g., listen to the tone playing at the speaker of the user device 103), and determine that the prompt is for the user to enter a destination number 230 at the user device 103 (e.g., via the user interface, a keypad, a microphone, or other device/component of the user device 103).

The user may then enter the destination number 230 into the user device 103 (e.g., via the user interface, a keypad, a microphone, or other device/component of the user device 103). At operation 821, the user device 103 may transmit the destination number 230 to the emergency system 109 (e.g., via the audio stream as DTMF tones or via an X-header 203 of a SIP invite 200). In some cases, the application 120 may determine whether the user device 103 is permitted to connect to the requested destination number 230 (e.g., based on permissions 124 of a user account 125 associated with a device identifier 140 of the user device 103). For example, when a device identifier 140 of the calling user device 103 is indicated in an access history 137 of one or more user accounts 125, the application 120 may verify that the user device 103 is permitted to connect to the requested destination number 230 based on the permissions 134 in the one or more user accounts 125. When the user device 103 is permitted to connect to the requested destination number 230 (e.g., there are no restrictions to the connection indicated in any permissions 143 at the data store 123), the application 120 may perform operation 824 to connect the user device 103 to the destination number 230.

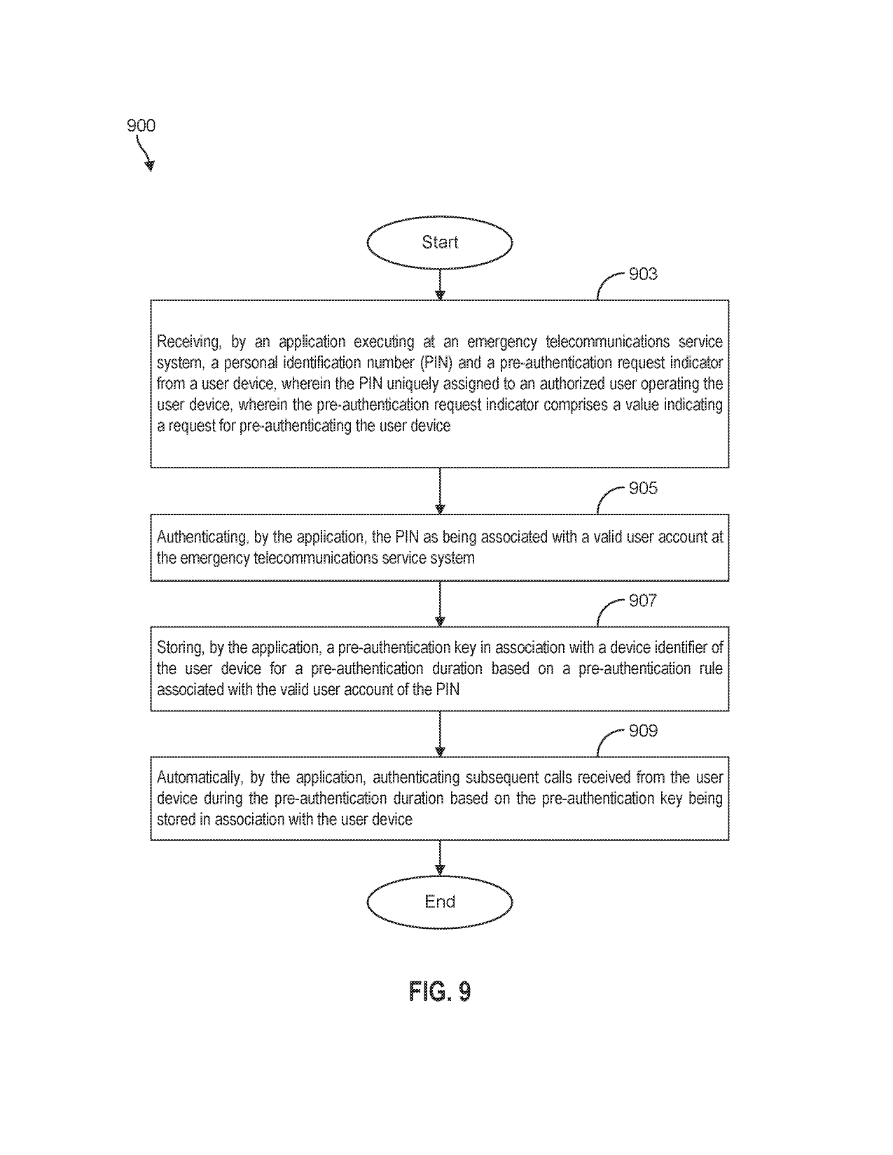

Referring now to FIG. 9, shown is a method 900 of providing optimized and prioritized telecommunication services to a user device 103 based on the methods 600, 700, and 800 of pre-authentication described above. Method 900 may be performed by the application 120 of the emergency system 109. In embodiments, the method 900 may be implemented using a computer system with components as shown in FIG. 11. As illustrated, method 900 of FIG. 9 includes a number of enumerated operations, but embodiments of the operations in FIG. 9 may include additional operations before, after, and in between the enumerated operations. In some embodiments, one or more of the enumerated operations may be omitted or performed in a different order. In the embodiment of method 900, the emergency system 109 provides GETS.

At step 903, method 900 comprises receiving, by an application 120 executing at an emergency telecommunications service system 109, a PIN 129 and a pre-authentication request indicator 610 from a user device 103. The PIN 129 is uniquely assigned to an authorized user operating the user device 103. The pre-authentication request indicator 610 comprises a value indicating a request for pre-authenticating the user device 103. At step 905, method 900 comprises authenticating, by the application 120, the PIN 129 as being associated with a valid user account 125 at the emergency telecommunications service system 109. At step 907, method 900 comprises storing, by the application 120, a pre-authentication key 133 in association with a device identifier 140 of the user device 103 for a pre-authentication duration 630 based on a pre-authentication rule 132 associated with the valid user account 125 of the PIN 129. At step 909, method 900 comprises automatically, by the application 120, authenticating subsequent calls received from the user device 103 during the pre-authentication duration 630 based on the pre-authentication key 133 being stored in association with the user device 103.

Method 900 may include other steps and/or features that are not otherwise shown in FIG. 9. In an embodiment, method 900 may further comprise receiving, by the application 120, a requested pre-authentication duration 621 from the user device 103, the requested pre-authentication duration 621 being an amount of time requested by the user device 103 for pre-authentication. In an embodiment, method 900 may further comprise obtaining, by the application 120, the pre-authentication rule 132 from the valid user account 125 of the PIN 129, in which the pre-authentication duration rule 132 indicates a maximum pre-authentication duration for which the one or more user devices 103 are permitted to pre-authenticate with the emergency telecommunications service system 109, and/or obtaining, by the application 120, the final pre-authentication duration 630 based on whether a requested pre-authentication duration 621 received from the user device 103 is less than or equal to the maximum pre-authentication duration. In this embodiment, when the requested pre-authentication duration 621 received from the user device 103 is less than or equal to the maximum pre-authentication duration, the requested pre-authentication duration 621 is the final pre-authentication duration 630, and/or wherein when the requested pre-authentication duration 621 received from the user device 103 is greater than the maximum pre-authentication duration, the maximum pre-authentication duration is the final pre-authentication duration 630.

In an embodiment the pre-authentication rule 132 indicates types of devices that are permitted to pre-authenticate with the emergency telecommunications service system 109 using the PIN 129. In an embodiment, the pre-authentication rule 132 indicates whether one or more user devices 103 are permitted to pre-authenticate with the emergency telecommunications service system 109 using the PIN 129.

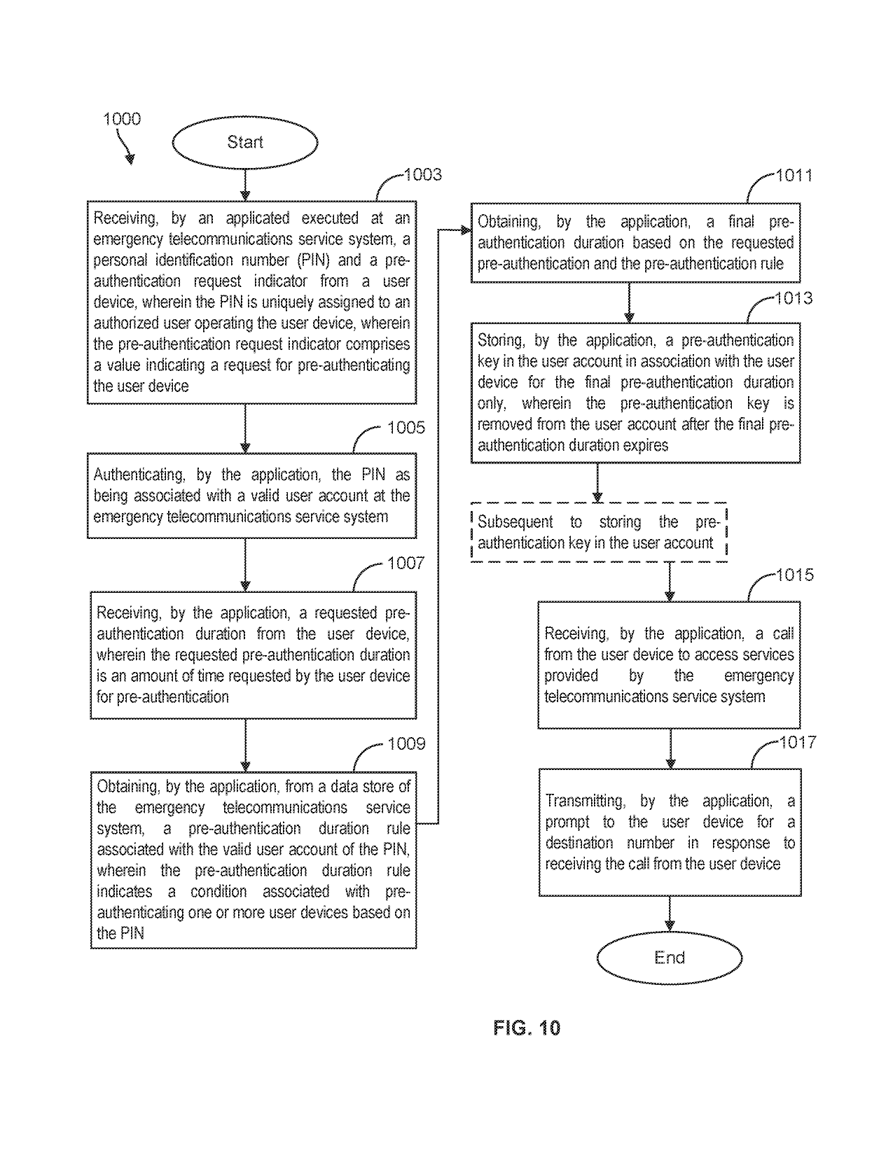

Referring now to FIG. 10, shown is a method 1000 of providing optimized and prioritized telecommunication services to a user device 103 based on the methods 600, 700, and 800 of pre-authentication described above. Method 1000 may be performed by the application 120 of the emergency system 109. In embodiments, the method 1000 may be implemented using a computer system with components as shown in FIG. 11. As illustrated, method 1000 of FIG. 10 includes a number of enumerated operations, but embodiments of the operations in FIG. 10 may include additional operations before, after, and in between the enumerated operations. In some embodiments, one or more of the enumerated operations may be omitted or performed in a different order. In the embodiment of method 1000, the emergency system 109 provides GETS.

At step 1003, method 1000 comprises receiving, by an application 120 executed at an emergency telecommunications service system 109, a PIN 129 and a pre-authentication request indicator 610 from a user device 103. The PIN 129 is uniquely assigned to an authorized user operating the user device 103, and the pre-authentication request indicator 610 comprises a value indicating a request for pre-authenticating the user device 103. At step 1005, method 1000 comprises authenticating, by the application 120, the PIN 129 as being associated with a valid user account 125 at the emergency telecommunications service system 109. At step 1007, method 1000 comprises receiving, by the application 120, a requested pre-authentication duration 621 from the user device 103. The requested pre-authentication duration 621 is an amount of time requested by the user device 103 for pre-authentication.

At step 1009, method 1000 comprises obtaining, by the application 120, from a data store 123 of the emergency telecommunications service system 109, a pre-authentication duration rule 132 associated with the valid user account 125 of the PIN 129. The pre-authentication duration rule 132 indicates a condition associated with pre-authenticating one or more user devices 103 based on the PIN 129. At step 1011, method 1000 comprises obtaining, by the application 120, a final pre-authentication duration 630 based on the requested pre-authentication duration 621 and the pre-authentication rule 132. At step 1013, method 1000 comprises storing, by the application 120, a pre-authentication key 133 in the user account 125 in association with the user device 103 for the final pre-authentication duration 630 only. The pre-authentication key 133 is removed from the user account 125 after the final pre-authentication duration 630 expires.

Steps 1015 and 1017 may be performed subsequent to storing the pre-authentication key 133 in the user account 125. At step 1015, method 1000 comprises receiving, by the application 120, a call from the user device 103 to access services provided by the emergency telecommunications service system 109. At step 1017, method 1000 comprises transmitting, by the application 120, a prompt to the user device 103 for a destination number 230 in response to receiving the call from the user device 103.

Method 1000 may include other steps and/or features that are not otherwise shown in FIG. 10. In an embodiment, method 1000 may further comprise determining, by the application 120, whether pre-authentication is permitted for the user device 103 based on the pre-authentication rule 132 or a second pre-authentication rule 132 associated with the valid user account 125 for the PIN 129. In an embodiment, the pre-authentication rule 132 indicates a maximum pre-authentication duration for which the one or more user devices 103 are permitted to pre-authenticate with the emergency telecommunications service system 109. In an embodiment, subsequent to storing the pre-authentication key 133 in the user account 125, the method further comprises bypassing, by the application 120, PIN 129 authentication of the user device 103 in response to determining that the pre-authentication key 133 is stored in the user account 125 in association with the user device 103.

In an embodiment, the requested pre-authentication duration 621 is a first number of days, and wherein obtaining the final pre-authentication duration 630 comprises modifying the requested pre-authentication duration 621 to be the maximum pre-authentication duration when the requested pre-authentication duration 621 is greater than the maximum pre-authentication duration. In an embodiment, the requested pre-authentication duration 621 is a first number of days, and wherein obtaining the final pre-authentication duration 630 comprises retaining the requested pre-authentication duration 621 as the final pre-authentication duration 630 when the requested pre-authentication duration 621 is less than or equal to the maximum pre-authentication duration.

In an embodiment, an emergency telecommunications service system comprises a memory, a processor, and an application stored in the memory is disclosed. The application, when executed by the processor, causes the application to be configured to receive emergency location data from one or more external systems, obtain a location region for pre-authentication based on the emergency location data, wherein the location region comprises latitude and longitude ranges within which an emergency situation is occurring, generate a location-based pre-authentication rule based on the location region, wherein the location-based pre-authentication rule indicates that user devices requesting access to the emergency telecommunications service system in the location region are permitted to be pre-authenticated for a pre-authentication duration, receive a call from a user device, wherein the call indicates a cell site location of a cell site serving the user device, determine that the cell site location is within the location region defined by the location-based pre-authentication rule, and bypass PIN authentication of the user device and transmit a prompt to the user device for a destination number when the cell site location is within the location region defined by the location-based pre-authentication rule.

In an embodiment, the application is further configured to determine the pre-authentication duration for the location-based pre-authentication rule based on the emergency location data and using an artificial intelligence model. In an embodiment, the call is a Session Initiation Protocol (SIP) invite, wherein the cell site location is carried in a header of the SIP invite. In an embodiment, the cell site location is a set of Global Positioning System (GPS) coordinates. In an embodiment, the application is further configured to receive the destination number from the user device, identify a user account in a data store of the emergency telecommunications service system, wherein the user account includes an access history indicating a device identifier of the user device, identify a permission included in the user account, and determine whether the user device is permitted to be connected to the destination number based on the permission. In an embodiment, the emergency location data includes a cumulation of different types of data indicative of the emergency situation occurring within the location region.

In an embodiment, a method implemented in a communication network to provide optimized and prioritized telecommunication services to authorized users is disclosed. The method comprises receiving, by an application executed at an emergency telecommunications service system, a personal identification number (PIN) and a pre-authentication request indicator from a user device, wherein the PIN is uniquely assigned to an authorized user operating the user device, wherein the pre-authentication request indicator comprises a value indicating a request for pre-authenticating the user device, authenticating, by the application, the PIN as being associated with a valid user account at the emergency telecommunications service system, receiving, by the application, a requested pre-authentication duration from the user device, wherein the requested pre-authentication duration is an amount of time requested by the user device for pre-authentication, obtaining, by the application, from a data store of the emergency telecommunications service system, a pre-authentication duration rule associated with the valid user account of the PIN, wherein the pre-authentication duration rule indicates a condition associated with pre-authenticating one or more user devices based on the PIN, obtaining, by the application, a final pre-authentication duration based on the requested pre-authentication and the pre-authentication rule, storing, by the application, a pre-authentication key in the user account in association with the user device for the final pre-authentication duration only, wherein the pre-authentication key is removed from the user account after the final pre-authentication duration expires, and subsequent to storing the pre-authentication key in the user account, receiving, by the application, a call from the user device to access services provided by the emergency telecommunications service system, and transmitting, by the application, a prompt to the user device for a destination number in response to receiving the call from the user device.

In another embodiment, a method comprises receiving, by an application executing at an emergency telecommunications service system, a personal identification number (PIN) and a pre-authentication request indicator from a user device, wherein the PIN is uniquely assigned to an authorized user operating the user device, wherein the pre-authentication request indicator comprises a value indicating a request for pre-authenticating the user device, authenticating, by the application, the PIN as being associated with a valid user account at the emergency telecommunications service system, storing, by the application, a pre-authentication key in association with a device identifier of the user device for a pre-authentication duration based on a pre-authentication rule associated with the valid user account of the PIN, and automatically, by the application, authenticating subsequent calls received from the user device during the pre-authentication duration based on the pre-authentication key being stored in association with the user device.

FIG. 11 illustrates a computer system 1100 suitable for implementing one or more embodiments disclosed herein. In an embodiment, the user devices 103, the emergency system 109, the AI model 114, and/or the voice verification system 112 may each be implemented as the computer system 1100. The computer system 1100 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 1100, at least one of the CPU 382, the RAM 388, and the ROM 386 are changed, transforming the computer system 1100 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 1100 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 1100 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 1100 to provide the functionality of a number of servers that is not directly bound to the number of computers in the computer system 1100. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 1100, at least portions of the contents of the computer program product to the secondary storage 384, to the ROM 386, to the RAM 388, and/or to other non-volatile memory and volatile memory of the computer system 1100. The processor 382 may process the executable instructions and/or data structures in part by directly accessing the computer program product, for example by reading from a CD-ROM disk inserted into a disk drive peripheral of the computer system 1100. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 1100.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 1100 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network to provide optimized and prioritized telecommunication services to authorized users, wherein the method comprises:
provisioning, by a dialer application executed at a user device in the communication network, an access number associated with an access network and a personal identification number (PIN) uniquely assigned to an authorized user operating the user device;
after the PIN and the access number are provisioned with the dialer application, receiving, by the dialer application, a destination number via a user interface at the user device;
generating, by the dialer application, a Session Initiation Protocol (SIP) invite including a device identifier identifying the user device and one or more X-headers, wherein the one or more X-headers comprises the PIN and the destination number;
transmitting, by the dialer application, the SIP invite to an emergency telecommunications service system;
extracting, by an application executed at the emergency telecommunications service system, the PIN from the one or more X-headers of the SIP invite;
authenticating, by the application, the PIN as being associated with a valid user account at the emergency telecommunications service system;
extracting, by the application, the destination number from the one or more X-headers of the SIP invite;
determining, by the application, that the user device is permitted to connect to the destination number based on a permission associated with the valid user account; and
completing, by the application, a call from the user device to the destination number.

2. The method of claim 1, further comprising encrypting, by the dialer application, the PIN based on a predefined encryption algorithm and a key prior to generating the SIP invite including the PIN.

3. The method of claim 2, further comprising decrypting, by the application, the PIN based on a predefined encryption algorithm and the key after extracting the PIN from the one or more X-headers of the SIP invite.

4. The method of claim 1, wherein the device identifier is carried in a “From” header of the SIP invite.

5. The method of claim 1, wherein the SIP invite further comprises session parameters governing a session between the user device and the emergency telecommunications service system.

6. The method of claim 1, wherein the SIP invite further comprises a cell site location indicating a location of a cell site serving the user device.

7. A user device, comprising:
a processor; and
a dialer application stored in a non-transitory memory of the user device, which when executed by the processor, causes the dialer application to be configured to:
provision a personal identification number (PIN) uniquely assigned to an authorized user operating the user device;
receive a destination number via a user interface after the PIN is provisioned;
encrypt the PIN based on a predefined encryption algorithm and a key to obtain an encrypted PIN;
generate a Session Initiation Protocol (SIP) invite including a first header, a second header, and an X-header,
wherein the first header comprises a device identifier identifying the user device and an X-header,
wherein the second header comprises a cell site location of a cell site serving the user device, and
wherein the X-header comprises the encrypted PIN and the destination number; and
transmit the SIP invite to an emergency telecommunications service system.

8. The user device of claim 7, wherein the first header is a “From” header of the SIP invite.

9. The user device of claim 7, wherein the second header is a “P-Access-Network-Info” header of the SIP invite.

10. The user device of claim 7, wherein the SIP invite comprises session parameters governing a session between the user device and the emergency telecommunications service system.

11. The user device of claim 9, wherein the PIN is a string of numeric digits.

12. The user device of claim 9, wherein the PIN is a voice passphrase.

13. A method, comprising:
receiving, by an application executing at an emergency telecommunications service system, from a user device, a Session Initiation Protocol (SIP) invite comprising a first header carrying a device identifier of the user device and an X-header carrying a personal identification number (PIN) of an authorized user operating the user device and a destination number requested by the user device;
extracting, by the application, the PIN and the destination number from the X-header;
authenticating, by the application, the PIN as being associated with a valid user account at the emergency telecommunications service system; and
completing, by the application, a call from the user device to the destination number.

14. The method of claim 13, wherein the device identifier of the user device comprises an automatic number identification (ANI) or a mobile station international subscriber directory number (MSISDN) of the user device.

15. The method of claim 13, further comprising decrypting, by the application, the PIN using a decryption algorithm and a key after extracting the PIN from the X-header.

16. The method of claim 15, wherein the key is based on a hash of the device identifier.

17. The method of claim 13, wherein the SIP invite further comprises a second header carrying a cell site location of a cell site serving the user device.

18. The method of claim 13, wherein the valid user account comprises a permission indicating whether the user device is permitted to complete a call with the destination number.

19. The method of claim 13, further comprising transmitting, by the application, a prompt to the user device permitting the user device to request another call.

20. The method of claim 13, wherein the PIN is a 12-digit numerical string.
